(19) United States
(12) Patent Application Publication
(10) Pub. No.: US 2009/0327203 A1
(43) Pub. Date: Dec. 31, 2009

(54) HOMOZYGOTE HAPLOTYPE METHOD

(76) Inventor: Koichi Hagiwara, Saitama (JP)

Correspondence Address: DAY PITNEY LLP, 7 TIMES SQUARE, NEW YORK, NY, 10036-7311, US

(21) Appl. No.: 12/309,994

(22) PCT Filed: Jun. 13, 2007
(86) PCT No.: PCT/JP2007/062368

§ 371 Date: Feb. 6, 2009

(30) Foreign Application Priority Data
Aug. 7, 2006 (JP) 2006-214300

(51) Int. Cl. G06N 5/02

(52) U.S. Cl. 706/54

(57) ABSTRACT

To provide a method of efficiently searching for a disease sensitivity gene and an apparatus therefor. It is intended to provide: a method of determining a homoeologous region which comprises the polymorphism marker selection step of selecting a polymorphism marker usable as the subject of the homozygote determination, the homozygote determination step of determining whether or not bases constituting a specimen DNA which is a diploid or higher are homozygous, the homozygote haplotype data acquisition step of selecting exclusively polymorphism markers determined as homozygous and acquiring homozygote haplotype data of each specimen, the homozygous region data acquisition step of comparing the above-described homozygote haplotype data of two or more specimens and acquiring common homozygous region data, and the homoeologous region determination step of determining a common homozygous region satisfying definite homoeology requirements as a homoeologous region between the corresponding specimens for each common homozygous region data; and an apparatus and a gene screening method with the use of this method.

### BACKGROUND OF THE INVENTION

1. Field of the Invention

The present invention relates to a method and device for efficiently searching for the chromosomal locations of disease susceptibility genes for monogenic diseases or polygenic diseases through using polymorphic markers.

2. Description of the Related Art

Identification of disease susceptibility genes is remarkably important for the development of disease treatment. Conventionally, an enormous amount of research related to such identification has been conducted for some time. Analysis methods have been developed for this purpose, such as a method that involves linkage analysis, affected sib-pair analysis, and homozygosity mapping that specify disease susceptibility gene regions.

“Linkage analysis” refers to a method used to narrow down the location of a causative gene on a chromosome based on the degree of linkage that exists between a phenotype-related locus and a marker locus on the chromosome. Additionally, “affected sib-pair analysis” refers to a method used to narrow down the location of a causative gene by conducting a comparison among siblings with the same disease. A polymorphic marker is used for such analyses (refer to non-patent document 1). “Polymorphism” refers to a difference in DNA bases. It is defined with reference to variations of certain bases that occur in more than 1% of the population. However, in reality, variations of bases occurring in less than 1% of the population correspond to “polymorphisms” in some cases. In the present invention, all bases that have variations are considered polymorphic. “Polymorphic marker” refers to a specific DNA polymorphism that is used as an indicator when disease susceptibility genes are searched. Regarding polymorphic markers, microsatellite polymorphisms, VNTR (Variable Number of Tandem Repeats) polymorphisms, and SNPs (Single Nucleotide Polymorphisms) are used for analysis. Polymorphism databases have been publicized, and such databases are used for analysis of disease susceptibility genes (refer to non-patent document 2). The dbSNP database (http://www.ncbi.nim.nih.gov/SNP/index.html) disclosed by NCBI and the JSNP (SNP for the Japanese people) database disclosed jointly by the Japan Science and Technology Corporation and the Institute of Medical Science of the University of Tokyo (http://snp.ims.u-tokyo.ac.jp) and the like are examples of such databases.

Additionally, as a homozygosity mapping method that uses polymorphisms, one method uses restriction fragment length polymorphisms (RFLP) as an SNP (refer to non-patent document 3). Another method uses microsatellite polymorphisms (refer to non-patent document 4).

Furthermore, there exists a type of analysis known as associated analysis that is a well-known method for identifying a disease susceptibility gene region. The associated analysis involves comparing the frequency of appearance of specific polymorphic markers in a control group and a diseased group, through which the locations of causative genes are narrowed down. SNP is used for this method. As an example of disease susceptibility gene identification that has actually been conducted by the linkage analysis and/or the associated analysis method mentioned above, the identification of a causative gene for type 11 diabetes (refer to patent document 1) is well known.
[Patent document 1] Kokai (Jpn. unexamined patent publication) No. 2002-339901
[Patent document 2] Japanese Patent Laid-open No. 2005-203654
[Non-patent document 1] “Genomuigaku Kara Genomuiryo He (Genome medicine to genome medical care)” written by Yusuke Nakamura published by YODOSHA CO., LTD. in 2005
[Non-patent document 2] Sellick, G. S. et al. Diabetes 52:2636, 2003
[Non-patent document 3] Lander, E. S. et al. Science 236:1567, 1987
[Non-patent document 4] Kobayashi, K. et al. Nature Genetics 22:159, 1997
[Non-patent document 5] Mariotta, S. et al. Sarcoidosis Vasc. Diffuse Lung Dis. 21:173-81, 2004
[Non-patent document 6] Castellana G. & Lamorgese V., Respiration 70:549-55, 2003
[Non-patent document 7] Tachibana T. et al. Sarcoidosis Vasc. Diffuse Lung Dis. 18 (suppl 1), 58, 2001

### SUMMARY OF THE INVENTION

### [Problems to Be Solved by the Invention]

Linkage analysis and affected sib-pair analysis are based on pedigree analysis. The aforementioned types of analysis involve difficulties in processes used to obtain samples as a step prior to performance of gene analysis thereof. In particular, in relation to low penetration rate diseases, in many cases, preservation of the number of samples that can lead to a significant conclusion constitutes a rate-determining step for analyses. Associated analysis has demerits in that such analysis requires a control group and reexaminations must be conducted due to the occurrence of many false-positive results.

Recently, patterns for DNA polymorphism of the human genome have been analyzed, and a haplotype map has been completed. Due to this, the relationship between haplotype and disease susceptibility gene has been researched. However, two pairs of chromosomes for human being exist. Even if all loci per person (polymorphisms) are understood, it is impossible to identify the haplotype which has caused such a locus. Thus, based on a disequilibrium analysis and the like, inference of a disease susceptibility gene is conducted. In order to obtain a significant p value, a large number of samples have been required, and enormous costs and time have been undertaken. There has existed such problem.

### [Means of Solving the Problems]

It is thought that disease pathogenesis for a certain group does not take place due to the fact that a mutation of the same gene occurs to different individual in a simultaneous manner. However, such mutation is considered to be mutation of a single gene of a single ancestor in many cases. That is to say, all base sequences corresponding to polymorphisms, such as for genetic abnormalities, SNPs, and microsatellite polymorphisms within regions in which the aforementioned disease susceptibility gene exists are stored in patients with the same disease. Therefore, a disease susceptibility gene exists within a region in which there exist the same base sequences among different individuals. Thus, in order to easily determine haplotypes of each individual, the present inventors have discovered a method that focuses on only homozygous polymorphic markers. Due to such method, two pairs of haplotypes owned by each individual can be considered to be sequences of a single haplotype. Such sequences of the haplotype are compared among different individuals. Thereby, it is possible to consider a region with the sequences of the same haplotypes to be a candidate region for gene inheritance from a single ancestor. Based on such discovery, the present invention provides a homoeologous region judging method that can result in a judgment based on a small number of samples with the use of polymorphic markers. Additionally, in the present invention, a homoeologous region judging device that judges whether a relevant region is a homoeologous region or not using polymorphic markers is provided. Moreover, a gene screening method for searching for a disease gene within the regions judged by the homoeologous region judging method or homoeologous region judging device is provided. That is to say, the present invention is as follows.

(1) The present invention provides a homoeologous region judging method, comprising the steps of determining whether the bases making up polymorphic markers of sample DNA indicating a state of diploidy or polyploidy indicate homozygosity, acquiring the homozygosity haplotype information for each sample through selecting only the polymorphic markers that have been judged as corresponding to a state of homozygosity, from among the polymorphic markers that have become the subject of the judgment by the homozygosity judging step, acquiring the common homozygous region information showing the region with the sequentially same homozygosity haplotype information through making a comparison with the homozygosity haplotype information of two or more of the samples, and judging that when continuous probability and/or continuous distance regarding polymorphic markers in regards to all common homozygous region information satisfy given homoeologous judgment conditions, the common homozygous region is a homoeologous region of samples.

(2) The present invention provides a homoeologous region judging method, comprising the steps of selecting polymorphic markers as the subject of judgment regarding homozygosity from among polymorphic markers of sample DNA indicating a state of diploidy or polyploidy, judging whether the bases making up the polymorphic markers of sample DNA indicating a state of diploidy or polyploidy indicate homozygosity or not, acquiring the homozygosity haplotype information for each sample through selecting the only the polymorphic markers that have been judged as corresponding to a state of homozygosity, from among the polymorphic markers that have become the subject of the judgment by the homozygosity judging step, acquiring the common homozygous region information showing the region with the sequentially same homozygosity haplotype information through making a comparison with the homozygosity haplotype information of two or more of the samples, and judging that when continuous probability and/or continuous distance regarding polymorphic markers in regards to all common homozygous region information satisfy given homoeologous judgment conditions, the common homozygous region is a homoeologous region of samples.

(3) The present invention provides the homoeologous region judging method, wherein the polymorphic marker selection step selects polymorphic markers through all chromosome regions of the sample DNA.

(4) The present invention provides the homoeologous region judging method, wherein the polymorphic marker selection step selects polymorphic markers included in regions corresponding to candidate gene regions.

(5) The present invention provides the homoeologous region judging method, wherein the sample DNA is of plant origin.

(6) The present invention provides the homoeologous region judging method, wherein the sample DNA is of animal origin.

(7) The present invention provides the homoeologous region judging method, wherein the sample DNA is of human origin.

(8) The present invention provides the homoeologous region judging method, wherein the sample DNA is of Japanese origin.

(9) The present invention provides the homoeologous region judging method, wherein the polymorphic markers correspond to SNPs.

(10) The present invention provides the homoeologous region judging method, wherein the polymorphic markers correspond to microsatellite polymorphism.

(11) The present invention provides the homoeologous region judging method, wherein the polymorphic markers correspond to VNTR polymorphism.

(12) The present invention provides the homoeologous region judging method, wherein polymorphic markers are based on a combination of two or more of any of SNP, microsatellite polymorphism, or VNTR polymorphism.

(13) The present invention provides the homoeologous region judging method in which the polymorphic marker selection step corresponds to the step in which the sample DNA is of human origin and in which 10,000 or more SNPs from all chromosome regions of the sample DNA are selected.

(14) The present invention provides the homoeologous region judging method in which the polymorphic marker selection step corresponds to the step wherein the sample DNA is of human origin and which selects 100,000 or more SNPs in all chromosome regions of the sample DNA.

(15) The present invention provides The homoeologous region judging method, wherein in regards to the given homoeologous judgment conditions of the common homoeologous region judging step, the continuous probability of a homozygous region of the polymorphic markers shown in the common homozygous region information can be a smaller value than that selected from the range of 1/10,000,000 to 1/10,000.

(16) The present invention provides The homoeologous region judging method, wherein in regards to the given homoeologous judgment conditions of the common homoeologous region judging step, the continuous probability of a homozygous region regarding the polymorphic markers shown in the common homozygous region information can be a smaller value than that selected from a scope of 1/5,000,000 to 1/50,000.

(17) The present invention provides the homoeologous region judging method, wherein in regards to the given homoeologous judgment conditions of the homoeologous region judging step, the continuous probability of a homozygous region regarding the polymorphic markers shown in the common homozygous region information can be a smaller value than that selected from a scope of 1/1,000,000 to 1/100,000.

(18) The present invention provides the homoeologous region judging method, wherein in regards to the given homoeologous judgment conditions of the homoeologous region judging step, the continuous probability of a homozygous region regarding the polymorphic markers shown in the common homozygous region information can be a smaller value than that selected from a scope of 1/1,000,000 to 1/5,000.

(19) The present invention provides The homoeologous region judging method, further comprising the steps of determining the combination of arbitrary two or more of any of any samples from among three or more of samples, and of executing the homozygous judging step, the homozygosity haplotype information acquisition step, the common homozygous region information acquisition step, and the homoeologous region judging step and of acquiring the homoeologous region overlapping frequency in which a region judged as being a homoeologous region in regards to each combination through the homoeologous region judging step.

(20) The present invention provides a gene screening method in which genetic sequences included in the homoeologous regions judged by the homoeologous region judging methods of any one of (1) through (19) are identified and are compared with sequences of normal genes.

(21) The present invention provides a gene screening method in which whether or not the homoeologous regions judged by the homoeologous region judging methods of any one of (1) through (19) could contain genes that have already been known to function in a homozygous state is determined, and in the case of a region that could contain a gene that has been already known, sequences of corresponding known genes and corresponding genes of sample DNA are compared.

(22) The present invention provides a gene screening method in which in case that the sample DNA corresponds to a disease, in case that the homoeologous regions judged by the homoeologous region judging methods of any one of claims (1) through (19) contain a gene that is expected to be related to a corresponding disease, the sequences of the corresponding genes of the sample DNA in the homoeologous region are identified and compared with normal genes.

(23) The present invention provides a homoeologous region judging device, comprising a homozygosity judging section in which whether or not bases comprising polymorphic markers in sample DNA indicating a state of diploidy or polyploidy indicate homozygosity is judged, a homozygosity haplotype information acquisition step in which from among the polymorphic markers that have become the subject of the judgment by the aforementioned homozygosity judging section, only the polymorphic markers that have been judged as corresponding to a state of homozygosity are selected, and the homozygosity haplotype information is obtained in regards to all samples, a common homozygous region information acquisition section which compares the homozygosity haplotype information of two or more of samples and which obtains the common homozygous region information showing a region with the sequentially same homozygosity haplotype information, and a homoeologous region judging section in which when continuous probability and/or continuous distance concerning the homozygous polymorphic markers satisfies the prescribed homoeologous judgment conditions in regards to all common homozygous region information, the information concerning the corresponding common homozygous region is judged as information concerning a homoeologous region of samples.

(24) The present invention provides a homoeologous region judging device comprising a polymorphic marker selection section in which polymorphic markers as the subject of judgment regarding homozygosity are selected from among polymorphic markers of sample DNA indicating a state of diploidy or polyploidy, a homozygosity judging section in which whether the bases making up the polymorphic markers of sample DNA indicating a state of diploidy or polyploidy indicate homozygosity or not is determined, a homozygosity haplotype information acquisition step in which from among the polymorphic markers that have become the subject of the judgment by the aforementioned homozygosity judging section, only the polymorphic markers that have been judged as corresponding to a state of homozygosity are selected, and the homozygosity haplotype information is obtained in regards to all samples, a common homozygous region information acquisition section which compares the homozygosity haplotype information of two or more of samples and which obtains the common homozygous region information showing a region with the sequentially same homozygosity haplotype information, and a homoeologous region judging section in which when continuous probability and/or continuous distance concerning the homozygous polymorphic markers satisfies the prescribed homoeologous judgment conditions in regards to all common homozygous region information, the corresponding common homozygous region information is judged as a homoeologous region of samples.

(25) The present invention provides the homoeologous region judging device, wherein polymorphic markers are selected through all chromosome regions of the sample DNA at the polymorphic marker selection section.

(26) The present invention provides the homoeologous region judging device, wherein the polymorphic markers included in regions corresponding to candidate gene regions are selected at the polymorphic marker selection section.

(27) The present invention provides the homoeologous region judging device, wherein the sample DNA is of plant origin.

(28) The present invention provides the homoeologous region judging device, wherein the sample DNA is of animal origin.

(29) The present invention provides the homoeologous region judging device, wherein the sample DNA is wherein the sample DNA is of human origin.

(30) The present invention provides the homoeologous region judging device, wherein the sample DNA is of Japanese origin.

(31) The present invention provides the homoeologous region judging device, wherein the polymorphic markers correspond to SNPs.

(32) The present invention provides the homoeologous region judging device, wherein the polymorphic markers correspond to microsatellite polymorphism.

(33) The present invention provides the homoeologous region judging device, wherein the polymorphic markers correspond to VNTR polymorphism.

(34) The present invention provides the homoeologous region judging device, wherein polymorphic markers are based on a combination of any two or more of SNP, microsatellite polymorphism, or VNTR polymorphism.

(35) The present invention provides the homoeologous region judging device in which the sample DNA is of human origin and in which 10,000 or more SNPs from all chromosome regions of the sample DNA are selected at the polymorphic marker selection section.

(36) The present invention provides the homoeologous region judging device in which the sample DNA is of human origin and which selects 100,000 or more SNPs in all chromosome regions of the sample DNA at the polymorphic marker selection section.

(37) The present invention provides the homoeologous region judging device in which in regards to the given homoeologous judgment conditions, the continuous probability of the polymorphic markers of the region shown in the common homozygous region information can be a smaller value than that selected from a scope of 1/10,000,000 to 1/10,000 at the homoeologous region judging section.

(38) The present invention provides the homoeologous region judging device in which in regards to the prescribed judgment conditions, the continuous probability of the polymorphic markers of the region shown in the common homozygous region information can be a smaller value than that selected from a scope of 1/5,000,000 to 1/50,000 at the homoeologous region judging section.

(39) The present invention provides the homoeologous region judging device in which in regards to the given homoeologous judgment conditions, the continuous probability of the polymorphic markers of the region shown in the common homozygous region information can be a smaller value than that selected from a scope of 1/1,000,000 to 1/100,000 at the homoeologous region judging section.

(40) The present invention provides the homoeologous region judging device in which in regards to the given homoeologous judgment conditions, the continuous probability of the polymorphic markers of the region shown in the common homozygous region information can be a smaller value than that selected from a scope of 1/1,000,000 to 1/5,000 at the homoeologous region judging section.

(41) The present invention provides the homoeologous region judging device further comprising a homoeologous region information output section which visualizes and outputs the homoeologous region information as information showing the common homozygous region judged to satisfy the given homoeologous judgment conditions by the homoeologous region judging section.

(42) The present invention provides the homoeologous region judging device which judges a homoeologous region in regards to three or more of samples of any one, further comprising, a combination determination section which determines the combination of arbitrary two or more of samples from among three or more of samples, and a homoeologous region overlapping frequency acquisition section in which a region judged as being a homoeologous region by the homoeologous region judging section in regards to each combination determined through the combination determination section acquires overlapping frequency among other combinations, wherein the common homozygous region information acquisition section obtains the common homozygous region information through making a comparison of the homozygosity haplotype information of samples in regards to the combinations determined by the combination determination section.

(43) The present invention provides the homoeologous region judging device further comprising a homoeologous region overlapping information output section that outputs the homoeologous region overlapping frequency information corresponding to visualized and outputted homoeologous region overlapping frequency obtained by the homoeologous region overlapping frequency information acquisition section.

(44) The present invention provides the homoeologous region judging device further comprising an overlapping homoeologous region information accumulation section that accumulates the overlapping homoeologous region information showing the homoeologous region information associated with the homoeologous region overlapping frequency obtained through the homoeologous region overlapping frequency acquisition section, and an important homoeologous region information acquisition section in which from among the overlapping homoeologous region information accumulated in the overlapping homoeologous region information accumulation section, the important homoeologous region information showing the homoeologous region information associated with an overlapping frequency that is greater than or equal to a given overlapping frequency is acquired.

(45) The present invention provides the homoeologous region judging device further comprising an important homoeologous region information output section that visualizes and outputs the important homoeologous region overlapping information obtained by the important homoeologous region information acquisition section.

(46) The present invention provides a gene screening method in which genetic sequences included in the homoeologous regions judged by the homoeologous region judging devices of any one of (23) through (45) are identified and are compared with sequences of normal genes.

(47) The present invention provides a gene screening method in which in case that the homoeologous region information identified by the homoeologous region judging devices of any one of (23) through (45) is overlapped with the homoeologous region information that is accumulated in the important homoeologous region information accumulation section, the gene sequences included in the overlapping region are identified and compared with the sequences of normal genes.

(48) The present invention provides a gene screening method in which it is judged whether or not the homoeologous regions judged by the homoeologous region judging devices of any one of (23) through (45) could contain genes that have already been known to function in a homozygous state, and in the case of a region that could contain a gene that has been already known, sequences of corresponding known genes and corresponding genes of sample DNA are compared.

(49) The present invention provides a gene screening method in which in case that the sample DNA corresponds to a disease, if the homoeologous regions judged by the homoeologous region judging devices of any one of (23) through (45) contain a gene that is expected to be related to a corresponding disease, the sequences of the corresponding genes in the homoeologous region of the sample DNA are identified and compared with normal genes.

### [Advantageous Effect of the Invention]

Due to a new method based on population genetics to the effect that a single individual is considered to a single haplotype, the present invention does not require pedigree analysis, inference of haplotypes, or a control group when searching for a disease susceptibility gene. Therefore, it is easy to preserve samples and possible to remarkably reduce the number of analyses carried out. Also, the present invention focuses only on homozygous genes. However, the present invention is useful in that it can be applied to searching for a causative gene of a dominantly inherited disease as well as that of a recessive hereditary disease. Moreover, in cases in which diseases are not currently occurring, it can be said that homoeologous regions are vulnerable portions in relation to diseases. This matter is also useful from the viewpoint of preventive medicine.

Moreover, by applying the present invention to plants and animals, it is possible to search for a causative gene in the same manner as with a human being in relation to diseases. Also, it is possible to discover genes that carry out useful functions and useful phenotype-related genes. Thus, the present invention can be used for the field of improvement in varieties and the like.

Additionally, based on performance of analyses in conjunction with the homozygosity fingerprint method invented by the present inventors (patent document 2), it is possible to improve accuracy of identification of a disease susceptibility gene concerning recessive genes.

### Detailed Description of the Preferred Embodiments

Hereinafter, the preferred embodiments for carrying out the present inventions are explained. The present inventions are not limited to such preferred embodiments, and can be implemented in various forms without deviation from the spirit or the main characteristics thereof.

A first embodiment mainly relates to claims 1, 5 through 12, 15 through 18, 23, 27 through 34, and 37 through 40. A second embodiment mainly relates to claims 2 through 4, 13, 14, 24 through 26, and 35, and 36. A third embodiment mainly relates to claims 19 and 42. A fourth embodiment mainly relates to claims 44. A fifth embodiment mainly relates to claims 41. A sixth embodiment mainly relates to claims 43 and 45. A seventh embodiment mainly relates to claims 20 through 22, and 46 through 49.

### First Embodiment

### Outline of a First Embodiment

First of all, the concept of the embodiment will be described with reference to FIG. 1. This Fig. shows a family tree of a certain family. Based on mutation and the like, A has a genetic disorder caused by a gene (in black). In such case, B and C, which are children of A, inherit a single chromosome from A. Based on crossover at the time of meiosis, a common portion with the chromosome having causative gene of A (in grey) becomes shorter. Such common portion is a homoeologous region. In here, in case that genetic disorder caused by a gene corresponds to a recessive hereditary disease, as in the case of F, if a causative gene derived from a common ancestor A becomes homozygous, a relevant disease is developed. Additionally, in the case of a dominant genetic disease, it may be possible for all members of B, C, D, E, and F with the causative gene to develop a relevant disease. However, in both cases of recessive inheritance and dominant inheritance, causative genes and proximity regions thereof are inherited. In such regions, all members of A through F have the same haplotype. Based on such fact, the present invention has been completed.

Therefore, based on the aforementioned fact, if the region with the same haplotype can be identified among the samples, the region in which the causative genes derived from the common ancestor exist can be identified. However, a human being has two units of chromosomes, it is normally difficult to determine haplotype with the homoeologous region. At this time, it is possible to consider two pairs of chromosomes as a haplotype by focusing only on the homozygous polymorphism. When such haplotype is compared among samples exhibiting the same disease, the haplotype of homoeologous region becomes common. It can be said that the region in which polymorphic sequences indicating the aforementioned haplotype become more common than those of the prescribed probability has a possibility of being a homoeologous region. That is to say, it can be said that there exists a high possibility in which in the case of dominant inheritance, causative genes derived from the common ancestor have been inherited by one of the parents. Alternatively, in the case of recessive inheritance, causative genes derived from the common ancestor have been inherited by the parents.

### Structure of a First Embodiment

An example of a functional block of the embodiment is shown in FIG. 1.” A homoeologous region judging device of the embodiment (0200) comprises a homozygosity judging section (0201), a homozygosity haplotype information acquisition section (0202), a common homozygous region information acquisition section (0203) and a homoeologous region judging section (0204).

The homozygosity judging section (0201) is configured so as to judge whether or not bases comprising polymorphic markers in sample DNA indicating a state of diploidy or polyploid indicate homozygosity. As a polymorphism typing method, the PCR-SSCP, PCR-RFLP, direct sequencing method, MALDI-TOF/MS method, TaqMan method, invader method, and the like can be used. The homozygosity judging section judges whether bases for which typing have been conducted via the aforementioned methods indicate homozygosity or not.

“Sample DNA” is genome DNA that serves as a sample used for identifying polymorphisms. Such sample DNA is not particularly limited, as long as such sample contains DNA indicating a state of diploidy or polyploidy. Samples may be of human origin, of non-human animal origin, and furthermore, of plant origin. In the case of samples of human origin, samples taken from a human of Japanese origin are desirable. The reason why the Japanese-derived DNA is desirable is that Japan is an insular country, which undertook a policy of isolationism. Due thereto, interbreeding with members of other ethnicities was less common. And thus there is a high probability that a Japanese individual would exhibit a homoeologous region derived from the common ancestor. On the other hand, for example, the U.S. is a country in which interbreeding among races takes place frequently, and it exhibits the phenomenon of low inbreeding coefficients. Due to crossover, homoeologous regions are shorter. Thus, it is difficult to judge homoeologous regions. Additionally, when bases comprising of polymorphic markers are compared with other samples, it becomes difficult to judge whether polymorphic markers are coincidentally matched or are due to a homoeologous state. Samples that allow use of genome DNA, such as blood, saliva, tissue, or cells, are acceptable. The reason why DNA indicating a state of diploidy or polyploidy applies is that whether or not a homologous chromosome indicates homozygosity cannot be judged based on a condition of monoploidy in the present invention. Therefore, in regards to sex chromosomes, in the case of females, an X chromosome can be in a homozygous state. Thus, it is possible to make relevant judgments. However, detection is impossible for males. Additionally, DNA indicating a state of triploidy or polyploidy is acceptable. The method of preparing genome DNA is not particularly limited, as long as a method suitable for the polymorphism typing method is used. For instance, when a method for conducting PCR is used, genome DNA must be prepared so that substances that are PCR inhibitors (EDTA, and the like) are not present.

A “polymorphic marker” uses a polymorphism, which involves a difference in DNA bases, as a marker when a disease susceptibility gene is searched for. Examples of polymorphisms include microsatellite polymorphisms, VNTR polymorphisms, and SNPs. As mentioned above, various polymorphism databases have been publicized. Tandem repeats of from two to dozens of bases exist on DNA. Most thereof do not have genetic information and exist in functionally unknown portions, and differences tend to take place among individual organisms. The frequency of occurrence of such repeated portions differs from individual to individual, and corresponds to polymorphism. Among such polymorphisms, polymorphisms of several to dozens of bases are called “VNTR polymorphisms.” And polymorphisms of two to four bases are called “microsatellite polymorphisms.” Additionally, “SNP” refers to a type of polymorphism that depends on monobasic differences in DNA. RFLP is contained in SNP. It is said that SNP frequently can be found in base sequences. It is also said that there is about one SNP per 300 bases in human beings, and 3 million to 10 million SNPs exist among the totality of chromosomes. In recent years, searches for disease susceptibility genes have been undertaken using such SNP differences. In the present invention, a microsatellite polymorphism or a VNTR polymorphism can be used as a polymorphic marker. Due to the existence of many polymorphisms, it is desirable to use SNP as a polymorphic marker in the present invention. Furthermore, a combination of more than two of any of SNP, microsatellite polymorphism, or VNTR polymorphism is acceptable.

“Homozygosity” refers to a situation in which all or parts of regions concerning homoeologous chromosomes have the same bases. That is to say, both of the opposing bases derived from the father and from the mother (pair of opposing bases) are the same. And a homozygous base pair corresponds to a state of homozygosity. A homozygous state does not involve a chromosome indicating a state of diploidy, and may be one indicating a state of triploidy or polyploidy. In such case, in case that all or parts of regions concerning homoeologous chromosomes that become pairs have the same bases, such bases can be said to indicate homozygosity. The homozygosity judging section determines whether or not an opposing pair comprising polymorphic markers correspond to any of A/A, B/B, or A/B (where A and B exhibit different bases in regards to all polymorphic marker locations). And in case that a result of measurement corresponds to A/A or B/B, the bases comprising polymorphic markers can be judged as a homozygous state of A or a homozygous state of B. As described above, the judgment as to whether or not bases comprising polymorphic markers correspond to a homozygous state is conducted to all polymorphic markers as the subjects of judgments.

The homozygosity haplotype information acquisition section (0202) is configured so that from among polymorphic markers as the subject of judgment carried out by the homozygosity judging section (0201) mentioned above, the only polymorphic markers that have been judged as indicating homozygosity are selected and homozygosity haplotype information is obtained in regards to each sample. “Homozygosity haplotype information” refers to the information indicating locations on the chromosomes, types of bases, and sequences thereof in relation to the polymorphic markers that have been judged as indicating homozygosity (hereinafter referred to as “Homozygous Polymorphic Marker(s)”). Based on such homozygosity haplotype information, a plurality of haplotypes of one organism can be considered to be one haplotype. For instance, a case where base sequences concerning polymorphic markers of chromosomes have been judged by the homozygosity judging section as per FIG. 3 (1) is considered. First of all, based on a result of judgment from the homozygosity judging section, the only Homozygous Polymorphic Markers (A/A or B/B) are selected. That is to say, the polymorphic markers judged as the heterojunction (A/B) are not considered in regards to determination of haplotypes. In case that the polymorphic markers correspond to SNPs, the percentage of homozygosity concerning SNPs for Asians is about 0.8 according to the data provided by Affymetrix, Inc. Thus, SNPs of about 80% from among SNPs as the subjects of measurements are selected. And since the only homozygosity is selected, as shown in FIG. 3 (2), one sequence of the Homozygous Polymorphic Markers of “ABBABA” is obtained. The information which shows such sequence corresponds to the homozygosity haplotype information. As such, differently from the normal concept of haplotypes, only through selecting of the Homozygous Polymorphic Markers, it is characterized that even two or more of chromosomes can be defined as a single haplotype.

The common homozygous region information acquisition section (0203) is configured so that the aforementioned homozygosity haplotype information concerning two or more of samples is compared and the common homozygous region information is obtained. “Common homozygous region” refers to a region showing the same homozygosity haplotype information in a serial manner, in regards to two or more of samples. “Common homozygous region information” refers to the information showing location on chromosomes showing the region and scope thereof. “the same . . . in a serial manner” refers to a situation where locations, bases, and sequences of the Homozygous Polymorphic Markers shown through the compared homozygosity haplotype information are matched. Explanations are made using FIG. 4. FIG. 4 (1) shows the homozygosity haplotype information of each sample. “•” shows locations of polymorphic markers judged as the heterojunction (A/B) for the easily comprehensible purpose concerning the locations of polyphonic markers(omitted in FIG. 3 (2)). At this time, common homozygous regions of samples 1 and 2 correspond to the portions of “A••A•B••B•B•A•B” (0401) and “ABBA•AB•B” (0402) surrounded by the frameworks which show sequentially same homozygosity haplotype in FIG. 4 (1). That is to say, the common homozygous region information corresponds to “AABBBABA” (0403) and “ABBAABB” (0404) as shown in FIG. 4 (2). That is to say, a border of the common homozygous region is formed by the Homozygous Polymorphic Markers which differ among samples. In addition, the common homozygous region may be obtained in regards to more than 3 samples. However, in regards to searching for disease susceptibility genes, it is desirable to obtain an initial candidate region in a broader manner. Thus, it is preferable to obtain the same from 2 samples.

Another example is shown in FIG. 5. FIG. 5 (1) shows the homozygosity haplotype information of each sample. “•” shows the portions of polymorphic markers judged as the heterojunction (A/B) in the same case of FIG. 4. When the homozygosity haplotype s of samples 1 and 2 are compared, there exist no Homozygous Polymorphic Markers in the locations shown by a of sample 1 and b of sample 2. In such case, instead of comparing of the Homozygous Polymorphic Markers which exist in regards to the only single sample, the only Homozygous Polymorphic Markers in the locations existing in both samples are compared. This is because when a single chromosome has a region derived from the common ancestor, such case corresponds to a state of heterojunction. Thus, such region cannot be ignored. In regards to the homozygosity haplotype information acquisition section, the only Homozygous Polymorphic Markers are selected. This is because sample DNA is defined as a single haplotype. And heterozygous genes are not necessarily eliminated. Thus, as per FIG. 5 (2), it is also possible to detect heterozygous bases existing among the Homozygous Polymorphic Markers as the common homozygous regions through making a comparison of the only the Homozygous Polymorphic Markers existing in both samples.

The common homozygous region has the sequentially same haplotype as mentioned above. Thus, there is a high possibility that such region would be derived from the chromosome of the common ancestor. In regards to the same disease, when such disease is caused by one gene mutation, it can be thought that the possibility of a case of genetic propagation of mutation occurring from a single ancestor is higher than a case in which the same mutation occurs to and results in a disease for individual patients. Therefore, it is highly possible that sequences in the proximity of corresponding gene would be inherited. Thus, it can be said that the corresponding gene exists within the homozygous region. In addition, the only polymorphic markers which become homozygous are observed in the present invention. However, this concept is applicable to not only recessive genes, but also dominant genes.

The homoeologous region judging section (0204) is configured so that when continuous probability and/or continuous distance regarding Homozygous Polymorphic Markers in relation to common homozygous region information satisfies given homoeologous judgment conditions, it is judged that the common homozygous region is a homoeologous region among the samples. “Continuous probability” refers to the probability of the same Homozygous Polymorphic Markers being in sequence. That is to say, the continuous probability is the value resulting when the homozygosity ratio for continuous polymorphic markers is multiplied, and it represents the probability of the same haplotype occurring as a result of a coincidence. “Homozygosity ratio” refers to the probability for the homoeologous chromosome to become homozygous. In regards to the polymorphisms, the probabilities of being bases in regards to the locations of the chromosomes (probability of A and probability of B) have been computed. Thus, homozygosity ratio can be also computed. That is to say, when the probability of A corresponds to P_{A} and the probability of B corresponds to P_{B}, the probability for the homoeologous chromosome to become A/A can be computed based on P_{A}·P_{A}/(P_{A}·P_{A}+P_{B}·P_{B}). By the same token, the probability for the homoeologous chromosome to become B/B can be computed based on P_{B}·P_{B}/(P_{A}·P_{A}+P_{B}·P_{B}). The probability differs from group to group. Thus, it would be better to use probability that is suitable for a given sample. For example, in the case of human beings, the homozygosity ratio concerning polymorphisms differs between the Japanese group and the American group. Thus, in the case of Japanese samples, it is desirable to compute continuous portability using the homozygosity ratio for Japanese or for Asians. Computation is acceptable by using targeted samples for each group regarding which detection is undertaken. “Continuous distance” refers to the length of the same Homozygous Polymorphic Markers in sequence. “Distance” refers to physical distance, using the unit of the base pair. That is to say, “continuous distance” refers to the length between the Homozygous Polymorphic Markers of both ends of a common homozygous region.

“Homoeologous judgment conditions” refer to conditions concerning continuous probability or continuous distance that are judgment standards regarding whether common homozygous regions correspond to homoeologous regions or not. Homozygous Polymorphic Markers alternatively indicate either a homozygous state of A/A or a homozygous state of B/B. Thus, there could exist a case where the same Homozygous Polymorphic Markers are in sequence and presents the same haplotype as a result of coincidence. In order to exclude regions in which the same haplotype results from coincidences, relevant conditions are established. For instance, a common homozygous region in which the continuous probability becomes less than or equal to 1/10⁵ can be established as a homoeologous region. The probability shows that when judgment is made using 10⁵ polymorphic markers, only about one portion is judged as a homoeologous region that results from the coincidental same haplotype.

Additionally, the homoeologous judgment conditions can be determined by continuous distance. A relevant continuous distance can be also determined by the average homozygosity ratio value concerning polymorphic markers to be detected and average value of the length between polymorphic markers. For example, when polymorphic markers of 100,000 locations are detected, the average value of the homozygosity ratio thereof is 0.74, and an average value between polymorphic markers of 23.6 kb, 900 kb, or more can be established as a homoeologous judgment condition. When the ratio is unknown, the continuous probability of a common homozygous region cannot be known. Thus, it is desirable to use the continuous distance that can be obtained from the average value of the homozygosity ratio as a homoeologous judgment condition. Alternatively, in case that both continuous probability and continuous distance are used, a case where any one of the aforementioned conditions is satisfied or a case where both conditions are satisfied may be used as a judgment condition, The homoeologous region judging section (0104) recognizes a common homozygous region (region in which the same homozygosity haplotype is shown in a continuous manner) that satisfies the aforementioned homoeologous judgment conditions as a homoeologous region.

However, a homoeologous region should not be immediately judged as a region that is composed of only a judged common homozygous region. This is because there is also a possibility that a region that exists up to the Homozyous Polymorphic Markers adjacent to the Homozyous Polymorphic Markers at both ends of the common homozygous region is a homoeologous region as a matter of fact. Despite the fact, since the polymorphic markers have not existed or the polymorphic markers correspond to heterojunction, or since the polymorphic markers have corresponded to heterojunction regions, the aforementioned region is judged as a non homoeologous region. Thus, the portion located up to the Homozygous Polymorphic Markers that have shown the different homozygosity haplotype may be included in a homoeologous region. That is to say, in the case of FIG. 4, a region “AABBBAB” that has been judged as a homoeologous region including a region “B(A)AABBBABA (B)” that contains the adjacent Homozyous Polymorphic Markers may be a homoeologous region.

In regards to homoeologous judgment conditions, the continuous probability of a common homozygous region being a significant homoeologous region can be less than or equal to 1/10⁷−1/10⁴. Due to the number of polymorphic markers, in the case of probability that is greater than or equal to 1/10⁴, it is impossible to judge a significant homoeologous region due to excessively many regions that would be judged as being homoeologous regions. And in the case of probability that is less than or equal to 1/10⁷, since such case is judged as being homoeologous regions, there exist too many Homozygous Polymorphic Markers which must be matched in a continuous manner. Thus, there is a possibility that the number of regions that would be recognized as homoeologous regions would be too small. It is said that human SNP is about 10⁷ units. Thus, when all SNPs are detected and there exists a portion in which the same haplotype is coincidental and is less than or equal to one portion, such region can be said to be a significant homoeologous region. Preferably, in relation to homoeologous judgment conditions, the continuous probability can be less than or equal to 1/(5×10⁶)−1/(5×10⁴). Further preferably, in relation to homoeologous judgment conditions, the continuous probability can be less than or equal to 1/10⁶−1/10⁵. In case that the number of polymorphic markers to be measured is small, in relation to homoeologous judgment conditions, the continuous probability can be less than or equal to 1/10⁶−1/(5×10³). In addition, in case that it is intended that the probability in which an actually homoeologous regions are excluded as being judged as non homoeologous regions is set to be lower, the homoeologous judgment conditions can be established in a loose manner.

As a homoeologous region undergoes generations, such region becomes shorter due to crossover, and has diversities. However, it can be said that the haplotype within the homoeologous region is preserved. Thus, the present inventor has called a homoeologous region judging method using this haplotype the “homozygosity haplotyping method.”

One example of a computer-based configuration comprising the homozygosity judging section, the homozygosity haplotype information acquisition section, the common homozygous region information acquisition section, and the homoeologous region judging section as mentioned above is given as follows.

First of all, the homozygosity judging section acquires base sequence data for polymorphic markers of sample DNA indicating a state of diploidy or polyploidy for each chromosome. Such data is composed of location information, which specifies locations of the bases for each chromosome, and base type information, which specifies types of polymorphic markers (adenine, guanine, cytosine, and thymine) related to the aforementioned location information. Such data is called “basic sample DNA data.” In regards to such basic sample DNA data, the output data of sequencer, and the like is acquired via communication and recording media, and the resulted data is stored in a storage area, such as a hard disk drive or RAM.

Additionally, the location information and homozygosity ratio information regarding a polymorphic marker are separately stored as a polymorphic marker file. Here, “homozygosity ratio information” refers to information concerning the probability that specific polymorphic markers would become homozygous, and such probability is generally acquired statistically. The location information regarding polymorphic markers is sequentially read from the storage region. And based on the read location information regarding polymorphic markers as a key, the process of searching for the aforementioned storage region is executed. The base type information to which such location information is related is acquired from basic sample DNA data of chromosomes, and the resulting information is temporarily stored in a storage region. Subsequently, it is determined whether or not the base type information stored temporarily in the storage region to which the same location information is related in regards to chromosomes is the same for all location information via the use of the comparison function of a CPU. In relation to location information for which comparison results are the same, a mark to the effect that such results are the same is made. And in the case that the results are not the same, a mark to the effect that such results are not the same is made. And such information is stored in storage region as a file related to location information. Such file is called a “homozygosity location information file.”

Subsequently, from among the homozygosity location information files stored in the storage region, the homozygosity haplotype information acquisition section extracts the only location information relating to homozygosity. First of all, the location information relating to homozygosity is sequentially read out. And the base type information which is related to the location information mentioned above is obtained. Next, the base type information as well as the location information are stored in the storage region as a homozygosity haplotype information file. Such file is called a “homozygosity haplotype information file.” The actions mentioned above are conducted in regards to two or more of samples, and a plurality of homozygosity haplotype information files are obtained.

Next, the common homozygous region information acquisition section extracts a region which shows the common haplotype from among two or more of homozygosity haplotype information files which have been stored in a storage region. Examples in which two or more of homozygosity haplotype information files are compared are explained hereinafter. The location information which is commonly included in both files is read out in a sequential manner. And the base type information related to the Homozygous Polymorphic Makers is matched, a sequentially common mark to the effect that the corresponding information is sequentially common is recorded in relation to two pieces of location information mentioned above. In case that the location information which is related to specific sequential mark shares the location information which is related to other sequential marks, such sequence shows that three or more of Homozygous Polymorphic Makers are sequentially common. A file in which such sequentially common marks and location information are related to each other is stored in the storage region as a sequentially common mark file.

Next, the homoeologous region judging section judges whether from among sequentially common mark files, sharing of the location information is in sequence or not, and determines whether a common homozygous region corresponds to a homoeologous region or not according to the degree of such sequence. Specifically, the homozygosity ratio information stored as being related to the location information regarding sequential Homozygous Polymorphic Markers is sequentially multiplied, and the probability that such sequence takes place due to reasons other than being homoeologous is computed. The computed probability is preserved in a given storage region, and the values stored in other storage regions as homoeologous judgment conditions are obtained. And comparison with the computed probability preserved in a given storage region is executed using the comparison function of a CPU. As a result of comparison, in case that the computed probability is judged as being a smaller probability than that determined by homoeologous judgment conditions, the location information showing corresponding regions is stored in the storage region as location information showing a homoeologous region. The location information indicating the homoeologous region contains all location information concerning Homozygous Polymorphic Markers included in the homoeologous regions as well as the location information regarding polymorphic markers indicating both ends of the homoeologous region. Such file is called a “homoeologous region file.” Ultimately, when the location information stored in the homoeologous region file is outputted, it is possible to specify the homoeologous region.

### Description of a First Embodiment

FIG. 6 shows a description of processing concerning the homoeologous region judging method of the first embodiment. First of all, it is determined whether bases that are composed of polymorphic markers of all sample DNAs indicating a state of diploidy or polyploidy correspond to a state of homozygosity or not (homozygosity judging step: S0601). Subsequently, from among the polymorphic markers that have become the subject of the judgment by the aforementioned homozygosity judging step, the only polymorphic markers that have been judged as corresponding to a state of homozygosity are selected, and the homozygosity haplotype information is obtained in regards to all sample DNAs (homozygosity haplotype information acquisition step: S0602). And the aforementioned homozygosity haplotype information of two or more of samples is compared, and the common homozygous region information which shows a region with the same homozygosity haplotype information is acquired (common homozygous region information acquisition step: S0603). Finally, a region in which a continuous probability and/or continuous distance of Homozygous Polymorphic Markers included in the common homozygous region information mentioned above satisfies the given homoeologous judgment conditions is judged as being a homoeologous region (homoeologous region judging step: S0604). The aforementioned process is not restricted to performance via the homoeologous region judging device of the present invention, and may be undertaken manually. The same applies to the following homoeologous region judging device.

### Effect of the First Embodiment

According to the homoeologous region judging device and method of the present embodiment, in case that human DNA, animal DNA, and plant DNA that give rise to a disease regarding which a causative gene has not yet been identified is used as a sample, it is possible to judge a homoeologous region which is a region with a high possibility of inclusion of a disease susceptibility gene. Additionally, according to the homoeologous region judging device and method of the present embodiment, it is possible to easily specify a candidate for a disease susceptibility gene with a smaller number of samples than that necessary with currently existing analysis methods. This is because neither family line analysis nor control group is necessary.

### Second Embodiment

### Outline of the Second Embodiment

The homoeologous region judging device and method of the embodiment comprises a polymorphic marker selection section that judges a homoeologous region using of the selected polymorphic markers.

### Configuration of the Second Embodiment

An example of a functional diagram of the embodiment is shown in FIG. 7. A homoeologous region judging device (0700) of the embodiment comprises a polymorphic marker selection section (0701), a homozygosity judging section (0702), a homozygosity haplotype information acquisition section (0703), a common homozygous region information acquisition section (0704) and a homoeologous region judging section (0705).

The polymorphic marker selection section (0701) is configured so that polymorphic markers as the subject of judgment regarding homozygosity are selected from among polymorphic markers. “Polymorphic markers as the subject of judgment regarding homozygosity” refers to the polymorphic markers related to execution of judgment at the homozygosity judging section (0702) among DNA polymorphisms. It is not efficient to judge all polymorphic markers by the homozygosity judging section from the viewpoint of time and cost. Polymorphic markers are not located at equal intervals on chromosomes, and such intervals are varied. Additionally, in regards to use of overly adjacent polymorphic markers, there is a high possibility that both such markers are located within the homoeologous region, which has no importance in relation to identification of the homoeologous region. Thus, when the polymorphic markers are selected at a certain interval, it can reduce the number of markers to be detected, resulting in a more efficient method. For instance, in regards to selection of polymorphic markers, use of one marker per 5 to 10 kb can be possible. Additionally, it is thought that useful polymorphic markers do not exist in regards to telomeres and centromeres. Thus, such polymorphic markers can be excluded from the subject of judgment regarding homozygosity. A database of polymorphic markers has been complied. Therefore, when it is intended to examine all chromosomes for homoeologous regions, it would be ideal to equally choose polymorphic markers that are distributed over the chromosomes based on the information in the database. Moreover, when a gene region candidate has been already specified via associated analysis and affected sib-pair analysis, and the like, polymorphic markers existing within such candidate region are selected in a careful manner. Such selection can further narrow down gene region candidates.

According to the present invention, in case that the sample DNA is human DNA, if it is intended that SNP be used for polymorphic markers and polymorphic markers are selected from all chromosomes, it is desirable to select 10,000 or more SNPs. Furthermore, to make an even more comprehensive judgment, it is desirable to select 100,000 or more SNPs. In such case, a commercially distributed GeneChip (registered trademark) may be used.

One example of a computer-based configuration regarding the polymorphic marker selection section is given as follows. The location information and the homozygosity ratio information regarding polymorphic markers are stored in storage region as a polymorphic marker database in advance. Generally speaking, it is said that from thousands of to tens of thousands of polymorphic markers, hundreds of thousands of polymorphic markers, millions of polymorphic markers, or 10,000,000 polymorphic markers exist. Such matters differ according to the type of samples and polymorphic marker type. Therefore, apart from a case in which sufficient resources can be utilized in regards to computer resources, generally, it is preferable to select polymorphic markers regarding which homozygosity is judged from the aforementioned polymorphic markers. In regards to the method of selection, the number of polymorphic markers to be selected is determined in advance, in accordance with given rules, and selection is repeated until the number of the selected polymorphic markers reaches the predetermined number or until given conditions are met based on a value less than or equal to the predetermined number in advance. Such method is adopted. However, selection methods are not limited thereto. Given rules can be the rules by which selection is made so that physical length between polymorphic markers to be selected will belong to a given range, or rules by which selection is made so that the homozygosity ratio for a given number of selected and adjacent polymorphic markers will be less than or equal to given values. Also, a rule that one polymorphic marker should be selected per haplotype block via use of haplotype block information may be further added. Furthermore, in case that a region necessary for homoeologous judgment can be selected from all relevant genes based on the purpose of homoeologous judgment, the rules by which selection can be executed within the necessary region are acceptable. At any rate, a selection program, by which the rules for selection from the relevant database are stored in a given storage region and are developed in the main storage region and by which execution takes place via CPU, selects any of the aforementioned rules and executes selection of relevant polymorphic makers from polymorphic marker databases in accordance with the corresponding rules. The selected location information and homozygosity ratio information in regards to the polymorphic markers selected in accordance with the given rule are stored in the selected polymorphic storage region. A large amount of data stored in such storage region is called “the selected polymorphic marker file.” In addition, it is not necessary to execute such selection process every time the subsequent homozygosity judging step is executed. As long as selection is made in advance, the same selected polymorphic marker file may be used based on type or based on purpose of homoeologous judgment.

The homozygosity judging section (0702) of the embodiment is configured to judge whether the bases making up the polymorphic markers selected by the polymorphic marker selection section (0701) mentioned above indicate homozygosity or not in regards to sample DNA. The judging method is performed in the same manner that of the first embodiment. Processing of other sections is the same as that of the first embodiment. Thus, a description of such processing is omitted here. A computer-based configuration regarding the homozygosity judging section is the same as that of the first embodiment except for the use of a selected polymorphic marker file in lieu of a polymorphic marker file.

### Description of the Second Embodiment

FIG. 8 shows a description of processes of the homoeologous region judging method of the second embodiment. First of all, the polymorphic markers as the subject of judgment regarding homozygosity are selected from the polymorphic markers of sample DNA indicating a state of diploidy or polyploidy (polymorphic marker selection step: S0801), and determines whether the bases making up the polymorphic markers selected by the polymorphic marker selection step mentioned above indicate homozygosity or not (homozygosity judging step: S0802). Subsequently, from among the polymorphic markers which have been judged as the subject of judgment by the homozygosity judging step mentioned above, the only polymorphic markers which have been judged as being homozygous are selected. And in regards to all samples, the homozygosity haplotype information is obtained (homozygosity haplotype information acquisition step: S0803). The aforementioned homozygosity haplotype information of two or more of samples is compared, and the common homogyous region information which shows the same homozygosity haplotype information is acquired (common homozygous region information acquisition section: S0804). Finally, a region in which a continuous probability and/or continuous distance of Homozygous Polymorphic Markers included in the common homozygous region information mentioned above satisfies the given homoeologous judgment conditions is judged as being a homoeologous region (homoeologous region judging step: S0805).

### Effect of the Second Embodiment

Based on the homoeologous region judging method and device of the embodiment, selection of the polymorphic markers can omit detection of more than a sufficient number of polymorphic markers. Thus, the homoeologous region can be specified in an efficient manner from the viewpoint of time and costs. Moreover, when a gene region candidate has been specified via associated analysis or affected sib-pair analysis, and the like, selection of the polymorphic markers existing within the gene region candidate in a detailed manner can allow the gene region candidate to be narrowed down further.

### Third Embodiment

### Outline of the Third Embodiment

The homoeologous region judging device and method of the embodiment are characterized by acquisition of the overlapping frequency of a homoeologous region, and they can judge the high or low possibility of a region being homoeologous in regards to a group of samples as the subjects of measurement.

### Configuration of the Third Embodiment

An example of a functional diagram of the embodiment based on the first embodiment is provided in FIG. 9. The homoeologous region judging device (0900) of the embodiment comprises a homozygosity judging section (0901), a homozygosity haplotype information acquisition section (0902), a common homozygous region information acquisition section (0903), a homoeologous region judging section (0904), a homoeologous region overlapping frequency information acquisition section (0905), and a combination determination section (0906).

The combination determination section (0906) is configured so as to determine the combination of two or more arbitrary samples from among three or more samples. “The combination two or more arbitrary samples” refers to the combination of a plurality of different samples, such as on a basis of two sample units or three units. For instance, in the case of three samples of A, B, and C, it is possible to have a combination of three pairs of AB, BC, and CA. Furthermore, four pairs in total based on one set of three samples of A, B, and C can be possible. In case that there exist many samples to be combined, the common homozygous region becomes narrower. Thus, it is preferable to have a combination based on a smaller number of samples. Additionally, it is preferable to create many combinations so that it is possible to exclude a case in which haplotypes can be matched in a continental manner. That is to say, it is preferable to make a round-robin combination of two samples based on three or more of samples. For instance, in the case of 10 samples, by making combinations of 90 pairs, it is possible to obtain the maximum number of common homozygous regions.

The common homozygous region information acquisition section (0903) of the embodiment is configured so that the aforementioned homozygosity haplotype information concerning samples based on the combination through the combination determination section (0906) mentioned above is compared and the common homozygous region information is obtained. The homozygosity haplotype information is obtained in regards to all samples through the homozygosity haplotype information acquisition section (0903) in the same manner as a case of the first embodiment. And the homozygosity haplotype information is compared in regards to all combinations, and the common homozygous region information is obtained. In the case of 10 samples, if the combination of 90 pairs mentioned above applies through the combination determination section, 90 pieces of the common homozygous region information can be obtained. And the homoeologous region judging section (0904) judges whether or not all pieces of the common homozygous region information obtained as mentioned above satisfy the homoeologous judgment conditions, and determines the homoeologous regions.

One example of configuration based on a computer of the combination determination section and the common homozygous region information acquisition section of the embodiment is as follows. The combination determination section can select the combination of samples in accordance with given rules from among three or more of samples with prescribed numbers. Given rules may be the rules by which all combinations on a two-sample basis should be created, or the rules by which combinations on a two-sample basis in accordance with the order of the samples with the smallest numbers should be created. Due to execution of the combination program via CPU in order to implement given rules which is stored in the prescribed storage region, the combinations of samples are determined and the determined results are stored in the prescribed storage region.

Subsequently, the common homozygous region information acquisition section extracts a region which shows the common haplotype from among three or more of homozygosity haplotype information files which have been stored in a storage region, in the same manner as a case of the first embodiment. In the present embodiment, in accordance with the combination files, homozygosity haplotype information files are compared. First of all, the combinations of combination files are read out in a sequential manner. And corresponding homozygosity haplotype information files of relevant samples are selected from a storage region. In regards to the selected homozygosity haplotype information files, comparison is made via using of comparison function of CPU, and sequential mark files are created. Furthermore, subsequent homoeologous region files are created. Due to performance of such operation in regards to all combinations of combination files, homoeologous region files corresponding to the number of combinations determined by the combination determination section are stored.

The homoeologous region overlapping frequency acquisition section (0905) is configured so that the homoeologous region overlapping frequency is obtained. “The homoeologous region overlapping frequency” refers to frequency in which a region judged as a homoeologous region by the aforementioned homoeologous region judging section (0904) in regards to each combination determined by the combination determination section (0906) mentioned above exhibits overlapping among other combinations. “Overlapping” means that a homoeologous region for each combination matches a whole or a part of a homoeologous region for another homoeologous region of another combination. “Overlapping frequency” refers to the number of samples that exhibit overlapping among all samples in regards to homoeologous regions when homoeologous regions based on a plurality of different combinations are overlapped. This homoeologous region overlapping frequency is obtained with the overlapping frequency among a plurality of samples of specific homoeologous regions by being related to the relevant information as follows. For instance, such information includes the location of an overlapping homoeologous region, overlapping frequency, location of polymorphic markers included in a homoeologous region, and ID, and the like. Explanations are given with reference to FIG. 10. FIG. 10 shows homoeologous regions (shaded portions) on the same DNA with regard to 4 combinations from (1) through (4). For instance, the homoeologous region information in (1) includes information that regions “1” through “2”, and “3” through “4” are the homoeologous regions. When the homoeologous region information regarding 4 combinations is overlapped, the homoeologous regions are classified into regions a through l, and the overlapping frequency for each region is computed. In relation to b, f, i, and k of Fig., only one out of four samples is judged as being a homoeologous region, and thus the overlapping frequency is “1.” Computation is made in the same manner. And c, d, and g correspond to “2,” h corresponds to “3,” and e corresponds to “4.” In the case of a sample from each patient in which the same recessive gene disease has occurred, it can be said that the highest possibility that a causative gene for the disease would exist within a region as shown in e in which the overlapping frequency is high.

One example of configuration based on a computer of the homoeologous region overlapping frequency information acquisition section is as follows. As described in the first embodiment, the homoeologous region file contains location information showing a region in which the probability computed through the homoeologous region judging section is smaller than that determined under the homoeologous judgment conditions as the location information showing the homoeologous region.

The homoeologous region overlapping frequency information acquisition section acquires common location information from the multiple homoeologous region files created based on the different combinations preserved in the prescribed storage region. The common location information is related to frequency of appearance in regards to combinations with common location information, and the resulting information is preserved. That is to say, in case that the location information associated with “a” to “b” (where a and b correspond to the location of polymorphic markers) is included in a homoeologous region file for a specific combination, the location information for “a” to “b” is also included in a homoeologous region file for another separate combination, and homoeologous region files for 100 samples in total have “a” to “b” as common location information, the information for a region of “a” to “b” and the information of “100” are associated with each other, and such associated information is preserved. Such an associated and preserved file is called a “homoeologous region overlapping frequency file.” First, in regards to a computer program, “1” is allocated to the location information showing the polymorphic markers contained in each homoeologous region file, and such information is preserved. Subsequently, each file is sequentially searched for. When “1” is allocated to the same location information in regards to the second file, “1” is added to the location information as a value, and “2” is allocated. When “1” is allocated to the same location information in regards to the third file, “1” is further added, and “3” is allocated. When the same location information is not included in a homoeologous region file in relation to the fourth combination, “1” is not allocated. Thus, “0” is added to “3” allocated to the aforementioned location information or “3” is kept as it is without executing addition processing. This process is repeated for all files. The cumulative value is obtained. In relation to the location information that is not contained in a homoeologous region file for each combination, as mentioned above, “0” may be allocated as a value related to the location information for such sample, and such “0” value may be added. Alternatively, it is acceptable for addition processing not to be executed.

The cumulative value is associated with the location information of the Homozygous Polymorphic Markers and is recorded in a homoeologous region overlapping frequency file. Also, in case that a homoeologous file is added, “1” is allocated to the location information concerning polymorphic markers included in the added homoeologous region file, and such information is preserved. And due to adding such information to the recorded homoeologous region overlapping frequency file, a new homoeologous region overlapping frequency file is created. At this time, the previous homoeologous region overlapping frequency file is deleted. With the outputting of a final homoeologous region overlapping frequency file, it is possible to determine overlapping frequency of a homoeologous region.

Additionally, in case that there are errors in regards to an overlapped homoeologous region file or in the case of reduction of the number of files, the processing resulting when “1” allocated to the location information showing the polymorphic markers in the homoeologous region files that are intended to be extracted from the homoeologous region overlapping frequency files is subtracted is executed.

### Description of the Third Embodiment

FIG. 11 shows a description of processing of the homoeologous region judging method of the second embodiment. First of all, it is determined whether the bases making up polymorphic markers of sample DNA indicating a state of diploidy or polyploidy indicate homozygosity or not (homozygosity judging step: S1101). Subsequently, from among the polymorphic markers that have become the subject of judgment, the only polymorphic markers that have been judged as corresponding to a state of homozygosity are selected, and the homozygosity haplotype information is obtained in regards to all sample DNAs (homozygosity haplotype information acquisition step: S1102). And the combination concerning the arbitrary two or more of samples from among three or more of samples is determined (combination determination step: S1103). And the homozygosity haplotype information related to samples of the combination which has been determined is compared. Due to this, the common homozygous region information is acquired (common homozygous region information acquisition step: S1104). Next, a region in which a continuous probability and/or continuous distance of Homozygous Polymorphic Markers included in the common homozygous region information mentioned above satisfies the given homoeologous judgment conditions is judged as being a homoeologous region (homoeologous region judging step: S1105). The region judged as a homoeologous region in regards to each combination through the homoeologous region judging step mentioned above obtains overlapping frequency (homoeologous region overlapping frequency acquisition section: S1106).

### Effect of the Third Embodiment

According to the homoeologous region judging device and method of the present embodiment, in case that human DNA, animal DNA, and plant DNA that give rise to a disease regarding which a causative gene has not yet been identified is used as a sample, it is possible to narrow down a region that has a high possibility of having a disease causative gene. Additionally, upon performance of breed improvement operations for plants and animals such as livestock and the like, with the homoeologous region judging method of the present embodiment, it is possible to search for genes regarding which significant functions or characteristics are likely to occur.

### Fourth Embodiment

### Outline of the Fourth Embodiment

The homoeologous region judging device and method of the present embodiment are characterized by obtaining of the important homoeologous region information, and they can judge a homoeologous region with a high overlapping frequency in regard to groups of samples as the subjects of measurement.

### Configuration of the Fourth Embodiment

One functional block of the present embodiment based on the third embodiment is shown in FIG. 12. The homoeologous region judging device (1200) of the embodiment comprises a homozygosity judging section (1201), a homozygosity haplotype information acquisition section (1202), a common homozygous region information acquisition section (1203), a homoeologous region judging section (1204), a homoeologous region overlapping frequency acquisition section (1205), a combination determination section (1206), an overlapping homoeologous region information accumulation section (1207), and an important homoeologous region information acquisition section (1208).

The overlapping homoeologous region information accumulation section (1207) is configured such that the overlapping homoeologous region information is accumulated. “Overlapping homoeologous region information” refers to the homoeologous region information which corresponds to the homoeologous region overlapping frequency obtained through the homoeologous region overlapping frequency acquisition section (1205) mentioned above. “ . . . corresponds to” refers to “in conjunction with.” That is to say, the overlapping homoeologous region information refers to the information in which the homoeologous region information, such as location, continuous probability, and continuous distance of a homoeologous region, and location of polymorphic markers and ID included in a homoeologous region, and the like, is combined with the information related to homoeologous region overlapping frequency. The overlapping homoeologous region information accumulation section accumulates the information mentioned above.

The important homoeologous region information acquisition section (1208) is configured so that from among the overlapping homoeologous region information accumulated in the overlapping homoeologous region information accumulation section (1207) mentioned above, the important homoeologous region information is obtained. The important homoeologous region information is the homoeologous region information associated with an overlapping frequency that is greater than or equal to a given overlapping frequency. “A given overlapping frequency” refers to the established overlapping frequency. For example, such given overlapping frequency is established as “10.” In case that homoeologous regions for 30 pairs of combinations are judged, if the given overlapping frequency is “10,” from among the homoeologous region information of 30 pairs of combinations accumulated in the homoeologous region information accumulation section mentioned above, only the information regarding the homoeologous region determined as being the homoeologous region for 10 or more combinations can be obtained.

One example of a computer-based configuration regarding the overlapping homoeologous region information accumulation section and the important homoeologous region information acquisition section is as follows. The overlapping homoeologous region information accumulation section preserves a homoeologous region overlapping frequency file with which location information obtained by the homoeologous region overlapping frequency acquisition section mentioned above is associated in the storage region. Additionally, the homoeologous region overlapping frequency file may be stored with information relating to each sample's birthplace, habitat, disease, race, variety, or the like, and may be stored as a separate file classified by the aforementioned items.

From among the homoeologous region overlapping frequency files with which the location information stored in the overlapping homoeologous region information accumulation section mentioned above is associated, the important homoeologous region information acquisition section acquires the homoeologous region information of more than or equal to a given overlapping frequency. Such homoeologous region information of more than or equal to given overlapping frequency is called an “important homoeologous region file.” That is to say, in relation to the homoeologous region overlapping frequency file, in case that the information “A:20, B:50, and C:100 . . . (where all values are 100 from D to X), Y:50, Z:30” (where “A:20” represents the fact that polymorphic markers corresponding to the location of A are included in the “20” homoeologous region overlapping files) is stored, if homoeologous region information in which overlapping frequency is greater than or equal to 50 is specified, the location information of “from B to Y” is recorded in an important homoeologous region file. Ultimately, when the location information stored in the important homoeologous region file is outputted, it is possible to specify the important homoeologous region.

Also, genetic information is associated with location information, and such information is separately stored in the storage region in the form of a genetic information file. “Genetic information” refers to information regarding a protein encoded by genes. If a relationship with a disease is known, genetic information can be associated with information pertaining to disease names, and the like. In regards to such genetic information file, the existing database and output data are obtained via communications and recording media, and may be stored in a storage region, such as a hard disk drive or RAM. In case that location information regarding the homoeologous region overlapping frequency file includes a region in which recessive genes separately stored in the storage region exist, such genetic information may be associated with the homoeologous region overlapping frequency file and may be stored.

### Description of the Fourth Embodiment

FIG. 13 shows a description of processing of the fourth embodiment. First of all, it is determined whether the bases making up polymorphic markers of sample DNA indicating a state of diploidy or polyploidy indicate homozygosity or not (homozygosity judging step: S1301). Subsequently, from among the polymorphic markers that have become the subject of judgment, the only polymorphic markers that have been judged as corresponding to a state of homozygosity are selected, and the homozygosity haplotype information is obtained in regards to all samples (homozygosity haplotype information acquisition step: S1302). And the combination concerning the arbitrary two or more of samples from among three or more of samples is determined (combination determination step: S1303). And the homozygosity haplotype information related to samples of the combination which has been determined is compared. Due to this, the common homozygous region information is acquired (common homozygous region information acquisition step: S1304). Next, a region in which a continuous probability and/or continuous distance of Homozygous Polymorphic Markers included in the common homozygous region information mentioned above satisfies the given homoeologous judgment conditions is judged as being a homoeologous region (homoeologous region judging step: S1305). The region judged as a homoeologous region in regards to each combination through the homoeologous region judging step mentioned above obtains overlapping frequency (homoeologous region overlapping frequency acquisition section: S1306). And the overlapping homoeologous region information in which the obtained overlapping frequency is associated with the homoeologous region information is accumulated (overlapping homoeologous region information accumulation step: S1307). Ultimately, from among the overlapping homoeologous region information accumulated through the overlapping homoeologous region information accumulation step mentioned above, the important homoeologous region information accumulation is greater than or equal to a given overlapping frequency is acquired (important homoeologous region information acquisition step: S1308).

### Effect of the Fourth Embodiment

Via the homoeologous region judging device of the embodiment, from among the regions determined to be homoeologous regions in multiple combinations, only the regions in which overlapping frequency is far higher can be obtained. Due to this, when regions involving searching for disease susceptibility genes are narrowed down based on changes in set values for given overlapping frequency, adjustment of the number of candidate regions to be searched for can be possible.

### Fifth Embodiment

### Outline of the Fifth Embodiment

The homoeologous region judging device of the embodiment is characterized by visualizing and outputting the homoeologous region information, and it can easily judge the homoeologous region.

### Configuration of the Fifth Embodiment

An example of a functional diagram of the embodiment based on the first embodiment is shown in FIG. 14. The homoeologous region judging device (1400) of the embodiment comprises a homozygosity judging section (1401), a homozygosity haplotype information acquisition section (1402), a common homozygous region information acquisition section (1403), a homoeologous region judging section (1404), and a homoeologous region information output section (1405).

The homoeologous region information output section (1405) is configured so that the homoeologous region information is visualized and outputted. “Homoeologous region information” refers to information showing a region that has been judged as being satisfied with the homoeologous judgment conditions from among the common homozygosity regions by the homoeologous region judging section (1404) mentioned above. “Visualized and outputted” refers to making a viewable representation. For instance, relevant information can be outputted in the form of tables, graphs, or figures. Outputting can be undertaken by making indications on a display, by print-out, via writing using recording media, and the like. Visualized and outputted homoeologous region information allows for easy judgment of the location of a homoeologous region on chromosomes concerning two or more of samples.

One example of a computer-based configuration regarding the homoeologous region information output section is as follows. A homoeologous region file obtained by the homoeologous region judging section is outputted from the homoeologous region output section via the input and output interface. The location information regarding homoeologous regions stored in the homoeologous region file is read out sequentially, and the process of visualization of regions on the chromosomes corresponding to the location information is undertaken in accordance with the relevant rules. Such rules may be rules stipulating that the location information for both ends of the homoeologous region is arrayed starting with the location information corresponding to the lowest number based on numeric order of chromosomes, or may be rules stipulating that 100 kb of the length of a homoeologous region corresponds to a region with 1-mm width and that the resulting region be illustrated on a chromosome map. As an example, FIG. 15 shows what has been outputted on a chromosome map. The numbers in the left of the Fig. shows the chromosome numbers, and the regions in grey show chromosome regions excluding telomere or centromere. And the regions in black show the homoeologous regions. This Fig. indicates the homoeologous regions of two patients with the common disease (alveolar microlithiasis) explained through the Examples. As a matter of fact, it has been discovered that causative genes for alveolar microlithiasis exist in the regions shown by black arrows, which shows that this present invention is useful.

### Description of the Fifth Embodiment

One example of a description of processing of the fifth embodiment through a computer-based configuration is explained with reference to FIG. 16. In FIG. 16, SNP is used as a polymorphic marker. And as a homoeologous judgment condition, the continuous probability is set as being less than or equal to 1/10⁵, and homoeologous judgment has been conducted to two samples. First of all, when an SNP typing result is obtained, one sample is selected (S1601). Subsequently, SNP types are divided into three categories of A/A homo, B/B homo, and other (A/B hetero, or Nocall), and A, B, and 0 apply thereto respectively (S1602). The base that is indicated in regards to A and B must be determined in advance. “Nocall” means that the relevant base could not be detected. SNP is changed to be aligned based on relevant chromosomes and locations. Due to this process, the haplotype is determined (S1603). The processing of S1602 and S1603 is also conducted for another sample file.

And one of the chromosomes corresponding to the lowest value in a numeric order of chromosomes that has not been processed is selected (S1605). Types of homozygous SNPs that are the same in two samples are compared according to precedence of the selected chromosome corresponding to the lowest numeric value of location number thereof (S1606). Here, AA shows A/A homozygosity for both two samples. A homozygous SNP as the “start” of a common homozygosity haplotype is searched for (S1607-S1610). The homozygous SNP (AA or BB) corresponding to common homozygosity that is detected first is deemed to be the “start.” (S1610). Subsequently, an adjacent homozygous SNP is searched for (S1611). And if the SNP corresponds to a common type (AA, BB, or 00), the subsequent SNP is searched for (S1611). In case that the adjacent SNP is the common homozygous SNP (AA or BB)(“Yes” in S1513), the homozygosity ratio concerning SNP regarding sequential homozygosity is multiplied by the continuous probability (initial value is “1”) (S1614). However, if the adjacent SNP is the different homozygous SNP (AB or BA) (“Yes” in S1615), one homozygous SNP before the common SNP is deemed to be “end” of the homozygous region and the continuous probability is “1.” (S1616). Next, in case that all processes concerning the selected chromosomes are not finished (“No” in S1617), a step to search for SNP as being the “start” of homozygous regions (S1609) is returned. Such action is repeated until all SNPs concerning the selected chromosomes are searched for. All SNPs concerning the selected chromosomes are searched for (“Yes” in S1617), and it is confirmed whether or not the process for all chromosomes has been completed. In case that processes concerning all chromosomes are not finished (“No” in S1618), the searching of the next chromosome commences (S1605). When the processing of all chromosomes is finished (“Yes” in S1618), only the information concerning a region in which the value by which the homozygosity ratio is multiplied satisfies the homoeologous judgment conditions (less than or equal to 1/10⁵) is recorded in the form of visualization, and the resultant is outputted (S1619).

An example of the processing programs mentioned above is shown in FIG. 17 through FIG. 22. The following program executes judgment of homoeologous regions based on the condition that detection of 100,000 SNPs has been conducted and 1/10⁵ as a continuous probability applies to the homoeologous judgment condition. The programs shown in the Table are one example, and the relevant programs are not relevant thereby.

### Effect of the Fifth Embodiment

According to the homoeologous region judging device and method of the present embodiment, homoeologous region information can be virtualized and outputted. This can easily allow comparison with the location of an affected gene and visual comparison with other samples.

### Sixth Embodiment

### Outline of the Sixth Embodiment

The homoeologous region judging device of the present embodiment is characterized by visualizing and outputting of the homoeologous region overlapping frequency information or important homoeologous region information, and thereby can easily judge a homoeologous region.

### Configuration of the Sixth Embodiment

An example of a functional diagram of the embodiment based on the first embodiment is shown in FIG. 23. A homoeologous region judging device (2300) of the embodiment comprises a homozygosity judging section (1401), a homozygosity haplotype information acquisition section (2302), a common homoeologous region information acquisition section (2303), a homoeologous region judging section (2304), a homoeologous region overlapping frequency acquisition section (2305), a combination determination section (2306), an overlapping homoeologous region information accumulation section (2307), an important homoeologous region information acquisition section (2308), a homoeologous region overlapping frequency information output section (2309), and an important homoeologous region information output section (2310).

The homoeologous region overlapping frequency information output section (2309) is configured so as to output the homoeologous region overlapping frequency information. “The homoeologous region overlapping frequency information” refers to the information which corresponds to visualized homoeologous region overlapping frequency information obtained by homoeologous region overlapping frequency acquisition section (2305). Outputting of visualized homoeologous region overlapping frequency information can allow easy judgment as to the location of a homoeologous region with high overlapping frequency.

One example of a computer-based configuration regarding the homoeologous region overlapping frequency information output section is as follows. An overlapping frequency file obtained by the homoeologous region overlapping frequency information acquisition section is outputted by the homoeologous region overlapping frequency information output section via the input and output interface. The location information regarding homoeologous regions stored in the overlapping frequency file is read out sequentially, and the process of visualization concerning regions on the chromosomes corresponding to the location information is undertaken in accordance with the relevant rules. Such rules may be rules in which outputting takes place based on a graph under a condition such that a horizontal axis indicates the chromosome location and the vertical axis indicates overlapping frequency. As an example of a method of outputting, FIG. 24 shows the output on a chromosome map that involves relating the overlapping frequency to color density. A basic configuration of this Fig. is the same as that of FIG. 15. Darker regions indicate homoeologous regions with high overlapping frequencies. As such, it is easy to judge a region with a high overlapping frequency.

The important homoeologous region information output section (2310) is configured so that so that the important homoeologous region information obtained by the important homoeologous region information acquisition section (2308) mentioned above is visualized and outputted. Outputting of important visualized homoeologous region information can allow for easy judgment as to the location of a homoeologous region of more than the established high overlapping frequency.

One example of a computer-based configuration regarding the important homoeologous region information output section is as follows. An important homoeologous region file obtained by the important homoeologous region information acquisition section is outputted by the important homoeologous region information output section via the input and output interface. The location information regarding homoeologous regions stored in the important homoeologous region file is read out sequentially, and processing of visualization concerning regions on the chromosomes corresponding to the location information is undertaken in accordance with the relevant rules. Such rules may be the rules shown by a Table by which the location information concerning the important homoeologous region is arrayed from the information corresponding to the lowest value in a numeric order of chromosomes, or may be rules by which 100 kb of the length of important homoeologous region correspond to a region with 1-mm width, and the resulted region is illustrated on a chromosome map.

### Effect of the Sixth Embodiment

The homoeologous region information concerning a plurality of combinations is outputted as homoeologous region overlapping frequency visualization information or important homoeologous region information. Due to such outputting, it is possible to clarify the frequency of occurrence of a homoeologous region for a relevant group. The homoeologous region judging device with the homoeologous region overlapping frequency information output section can allow easy judgment concerning regions with the high overlapping frequency. Also, the homoeologous region judging device with the important homoeologous region information output section can output the only information corresponding to a homoeologous region with an established overlapping frequency or more. Thus, it is possible to restrict the region related to a gene search and to undertake efficient gene screening.

### Seventh Embodiment

### Outline of the Seventh Embodiment

The embodiment relates to a gene screening method with specific functions through using of the homoeologous region judging methods or homoeologous region judging devices mentioned in one of the first embodiment through sixth embodiment mentioned above.

### Embodiment 7-1

The embodiment 7-1 corresponds to a gene screening method in which genetic sequences included in the homoeologous regions judged by the homoeologous region judging methods or homoeologous region judging devices mentioned in one of the first embodiment through sixth embodiment are identified and are compared with sequences of normal genes.

This gene screening method is used to determine gene sequences within a region judged as being a homoeologous region and to compare the same with the sequences of normal genes. Thereby, gene sequences abnormalities in sample DNA are examined. In case that a sample DNA corresponding to a recessive gene disease for which the causative gene has not been known is used, regions judged as being homoeologous regions are candidate regions in which disease susceptibility genes exist. Determination of all gene sequences within a candidate region allows specification of disease susceptibility genes. That is to say, in case that abnormal genes exist in sample DNA corresponding to the same disease, such genes can be specified as causative genes. Moreover, even under strict homoeologous judgment conditions, when identification of gene sequences in a region judged as being a homoeologous region is conducted, it is possible to efficiently specify disease susceptibility genes.

### Embodiment 7-2

The embodiment 7-2 corresponds to a gene screening method in which when the homoeologous region information judged by the homoeologous region judging methods or homoeologous region judging devices mentioned in one of the first embodiment through sixth embodiment mentioned above is overlapped with the homoeologous region information which is accumulated in the overlapping homoeologous region information accumulation section mentioned above, and the gene sequences included in the overlapping region are identified and compared with the sequences of normal genes.

In case that the homoeologous region information regarding sample DNA that may or may not correspond to a disease is overlapped with the homoeologous region information that is connected with the disease information accumulated in the overlapping homoeologous region information accumulation section, gene sequences included in the overlapping region are identified and compared with the sequences of normal genes. Thereby, it can be judged whether a disease exists or not. The overlapping homoeologous region information accumulation section relates the location information concerning genes that could cause disease or genes that could cause significant characteristics to the homoeologous region information, and accumulates the resulted information. Due to this, it is possible to use the same for genetic diagnosis.

### Embodiment 7-3

The embodiment 7-3 corresponds to a gene screening method in which it is judged whether or not the homoeologous regions judged by the homoeologous region judging methods or homoeologous region judging devices mentioned in one of the first embodiment through sixth embodiment mentioned above could contain genes that have already been known to function in a homozygous state. In the case of a region that could contain a gene that has been already known, base sequences of corresponding known genes and corresponding genes of sample DNA are compared.

“Functions” may correspond to dominant characteristics as well as recessive characteristics. For instance, characteristics of being resistant to the cold or pests or characteristics of having a high sugar content are possible with homozygosity. In case that a homoeologous region of sample DNA is overlapped with a region which could contain a gene that is already known to serve its function by being homozygous, the base sequence of genes included in the overlapping region is identified and compared with the sequences of normal genes. Thereby, it is possible to examine the existence of corresponding genes. For instance, comparing a corresponding region with a causative gene region of a recessive gene can constitute a simple morbidity diagnosis concerning recessive gene disease can be diagnosed. In case that a sample's homoeologous region is overlapped with an affected gene region, the base sequences of genes are identified and causative genes are specified.

### Embodiment 7-4

The embodiment 7-4 corresponds to a gene screening method in which in case that the homoeologous regions judged by the homoeologous region judging methods or homoeologous region judging devices mentioned in one of the first embodiment through sixth embodiment mentioned above contain a corresponding gene that is expected to be related to a corresponding disease, the base sequences of the corresponding gene in the homoeologous region of the sample DNA mentioned above are identified and compared with normal genes.

“Gene that is expected” refers to a gene which can be expected to be related to a corresponding disease. For example, in the case of a disease which causes metabolic abnormality, a gene which codes enzyme related to metabolism applies. Moreover, in the case of a disease which causes immune abnormality, a gene which codes materials related to immunity applies. Thereby, it is possible to exclude a gene which cannot be expected to associate with a corresponding disease at all. Due to such exclusion, the number of genes which determine base sequences can be reduced. Based on the gene screening method of the embodiment, the identification of causative gene concerning alveolar microlithiasis has been conducted. Details thereof are explained in the example stated as below.

### Effect of the Seventh Embodiment

According to the gene screening method of the embodiment in which the gene screening is searched for among the homoeologous regions, it is possible to efficiently search for disease susceptibility genes. Additionally, this method has advantageous effects which allow gene screening of dominant inheritance as well as recessive gene.

### Example 1

Detailed explanations are given by using examples of the identification of the causative gene for alveolar microlithiasis. However, the present invention is not limited to such examples.

<Alveolar Microlithiasis>

Alveolar microlithiasis is a disease in which an unlimited number of fine stones composed of laminated and growth-ring-shaped layers of calcium phosphate are formed within the alveoli. It is a rare disease with unknown causes (non-patent document 5). This disease can be discovered from childhood to adulthood. However, there is no gender difference in regards to the onset of the disease. The symptoms differ by age. Normally, according to the cases discovered in the period from childhood through early adulthood, remarkably diffused lung shadows can be discovered via chest x-ray. Despite the fact, generally, patients are not aware of the symptoms. However, patents who are over 40 years old notice symptoms such as breathing difficulties or coughing during exercise. The long-term prognosis concerning this disease differs based on age at the time of discovery thereof. However, the prognosis is not always good. In particular, for middle-aged patients who are over 40 years old, as symptoms progress, respiratory symptoms such as coughing, breathing difficulties, or the like take place. Furthermore, many patients involving this disease die of respiratory failure as the symptoms progress.

The frequency of occurrence of this disease among siblings is high, and a tendency of horizontal transfer, such as among brothers and sisters, can be discovered. Thus, it is thought that such disease is a genetic lung disease based on autosomal recessive inheritance (non patent document 6). However, the relevant causative gene has not yet been identified. This is a rarely occurred disease. However, it can be said that potential frequency concerning the onset of such disease is high in the countries in which numbers of siblings are high, such as an insular country with a racially homogeneous population, or in counties in which the percentage of marriages accounted for by consanguineous marriages is high as a result of religious background. Thus, this disease cannot be ignored. In particular, in Japan, it is known that the number of cases of this disease is high compared with the rest of the world (non-patent document 7). Thus, investigation into the cause thereof and into treatment methods therefor is desired. However, effective methods of treatment other than relevant treatment such as oxygen therapy and lung transplantation have remained unknown.

<Sample>

DNA samples from 2 patients (patients 1 and 2) who started alveolar microlithiasis shown in FIG. 25 were used. Patients shown in black represent alveolar microlithiasis,and diagonal lines show the dead patients. Patients 1 and 2 correspond to a family with consanguineous marriage, and there are patients with alveolar microlithiasis within the family line. Sample DNAs have been adjusted from blood. As a method for extracting genome DNA, any publicly known method can be used in addition to the method shown as below.

Lysis buffer (final concentration: 100 μg/mI, Proteinase K, 50 mM Tris-HCL (pH 7.5), 10 mM CaCl₂, 1% SDS) was added to 5 ml of corresponding peripheral blood. The resultant was incubated for 30 minutes at 50° C., and cells were dissolved. Subsequently, phenol that had been saturated with TE buffer was added to the aforementioned cell lysate. Thereafter, a container was rotated several times, and the content was mixed. Subsequently, centrifugal treatment was conducted for 10 minutes at 3,000×g at room temperature. And the contents were separated into a water layer and phenol layer. Only the top water layer was extracted, and it was transferred to a new container. Again, an equal amount of phenol-chloroform mixture (mixing ratio 1:1) was added to such water layer. The container was rotated several times, and mixing was conducted. Next, centrifugal treatment was conducted for 10 minutes at 3,000×g at room temperature again. The contents were separated into the following three layers: water layer, interlayer (denatured protein layer), and phenol-chloroform layer. Then, only the water layer was extracted so that denatured proteins making up the interlayer would not be mixed therewith. Thereafter, until it became impossible to identify the interlayer, the aforementioned phenol-chloroform mixture treatment was repeated several times. Next, PNase A was added to the water layer sample obtained at the last stage so that the final concentration corresponded to 50 μg/ml. The resultant was incubated for 1 hour at 50° C., and RNA was dissolved. Subsequently, the aforementioned lysis buffer was added, Proteinase K treatment was undertaken, and RNase A in the water layer was deactivated. And an equal amount of the aforementioned phenol-chloroform mixture was added, and phenol-chloroform treatment was conducted again. 1/10 of the content of sodium acetate and an equal amount of isopropanol were added to the water layer contents after the treatment, and the resultant was gently stirred. Finally, the intended genome DNA was obtained by looping precipitated genome DNA with a glass. Alternatively, the intended genome DNA was obtained under after centrifugal treatment was conducted for 10 minutes at 3,000×g at room temperature.

<Selection of Polymorphic Markers>

Selection of polymorphic markers was conducted using the Affimetrix's GeneChip (registered trademark) Human Mapping 100k set, which allows evenly distributed allocation over the all chromosomes. The GeneChip Human Mapping 100k set can broadly cover regions except for telomere and centromere, and can detect about 100,000 SNPs simultaneously. Regions which contain at least one SNP within 100 kb account for 92% of all DNAs, 83% of those within 50 kb, and 40% of those within 10 kb. Thus, this method is desirable for identification of homoeologous regions when the cause of a disease has not been discovered. In FIG. 26, the SNP coverage region is shown.

<SNP Typing>

SNP typing was conducted in regards to sample DNAs mentioned above. Also, in order to preserve reliability concerning identification, analyses were conducted by the following two companies: the Australian Genome Research Facility and AROS applied biotechnology. The results of typing were remarkably well matched. SNP typing was conducted in accordance with the Affimetrix's GeneChip Mapping 100k Assay Manual.

<Identification of Homozygous Regions>

The following processing was conducted via using of the homoeologous region judging device of the present invention which executes the programs shown in FIG. 17 through FIG. 22. More specifically, first of all, based on the results of SNP typing, it was judged whether a relevant region corresponded to a state of homozygosity, and only the homozygous SNPs were selected. And depending on the types of bases concerning the selected homozygous SNPs, one haplotype was determined in regards to each sample. Subsequently, based on a round-robin combination of two samples based on three or more of samples, the common homozygous regions were determined. That is to say, the combinations of three pairs of patients 1•2, patients 2•3, and patients 3•1 applied. Based on such combinations, the common homozygous regions were identified. And the homozygous regions were judged under the homozygous condition that the continuous probability was 1/10⁵ or less.

The homologous regions identified as such can be visualized in the form shown in FIG. 15 by the homoeologous region information output section, and resultant information can be outputted. FIGS. 15 indicates the homoeologous regions of patients 1 and 2. A plurality of the homoeologous regions were detected. Thereby, it is discovered that there exits a possibility of having a plurality of common ancestors. However, certain regions were identified from among all chromosomes, and it was possible to narrow down candidate regions of disease causative genes.

<Identification of Causative Genes>

This disease is considered to be caused by a recessive gene. The homozygosity fingerprinting method (patent document 2) which the present inventors previously invented and regarding which the patent application was made thereby was conducted in conjunction, and furthermore, candidate regions were narrowed down. FIG. 27 shows the judgment of homoeologous regions of patients 1 and 2 via the homozygosity fingerprinting method, and further shows the output of the important homoeologous regions in which the overlapping frequency is “2.” FIG. 28 represents visualized the common regions in regards to the regions obtained through both such methods (homozygosity haplotyping method and homozygosity fingerprinting method). As shown in FIG. 28, despite the identification based on the only two patients, it can be recognized that the candidate regions of causative genes thereof were narrowed down to a narrower scope. The present inventors have discovered that the causative genes of alveolar microlithiasis correspond to the SLC34A2 genes which code phosphate symporter. Corresponding genes exist in the regions shown by an arrow in FIG. 28. And it has been proved that the present invention is useful.

<Observation>

Based on the results mentioned above, it has been proved that the homozygosity haplotyping method is useful. In conjunction with the homozygosity fingerprinting method, in regards to identification of low-permeability causative genes for alveolar microlithiasis, only 2 samples led to identification of candidate regions of causative genes. Thus, this fact suggests that it is possible to use the homozygosity haplotyping method for identification of other recessive disease genes with a small number of samples. Moreover, due to increasing of the number of samples and detection of a plurality of homoeologous regions among samples based on different combinations, it is possible to exclude homoeologous regions of common ancestors without causative genes from the candidate regions. In the case of using the only homozygosity haplotyping method, it can be thought to be possible to narrow down the candidate regions. Thus, it has been revealed that the homoeologous region judging method, homoeologous region judging device, and gene screening method of the present invention offer a remarkably effective analysis method in regards to identification of disease susceptibility genes.

### INDUSTRIAL APPLICABILITY

In regards to research regarding searches for disease susceptibility genes that require many family lines and control groups, the homoeologous region judging method, homoeologous region judging device, and gene screening method of the present invention allow identification of disease susceptibility genes with a small number of samples (3 samples for alveolar microlithiasis). The present invention makes it possible to identify causative genes with a small number of samples and without the need for family line analysis. Thus, the present invention can be also applied to low-permeability genetic diseases in which causative genes have not been identified because of a lack of cases at present. The identified genes will have a high degree of usability in the area of drug discovery. Moreover, due to observation of overlapping frequency in multiple samples, when multiple overlapping regions exist, it is possible to specify multiple candidate regions in regards to disease susceptibility genes. Thus, the present invention can be applied to polygenic diseases. In regards to a sample without diseases and a family line exhibiting consanguineous marriages, with identification as to whether regions existing affected genes correspond to homoeologous regions or not, it is possible to use the present invention for simple diagnoses of genetic diseases. Moreover, the usability of the present invention is remarkably high in that it is possible to search for disease susceptibility genes of dominantly inherited disease which became difficult to be searched for conventionally.

Furthermore, the present invention can be used for identification of genes that serve useful functions and genes that would result in useful characteristics. Thus, there is a high degree of industrial applicability relating to performance of breed improvement operations for plants and animals, and the usability is remarkably high in the fields of livestock and agriculture.

### BRIEF DESCRIPTION OF DRAWINGS

FIG. 1 is an explanatory diagram relating to the concept of a homoeologous region.

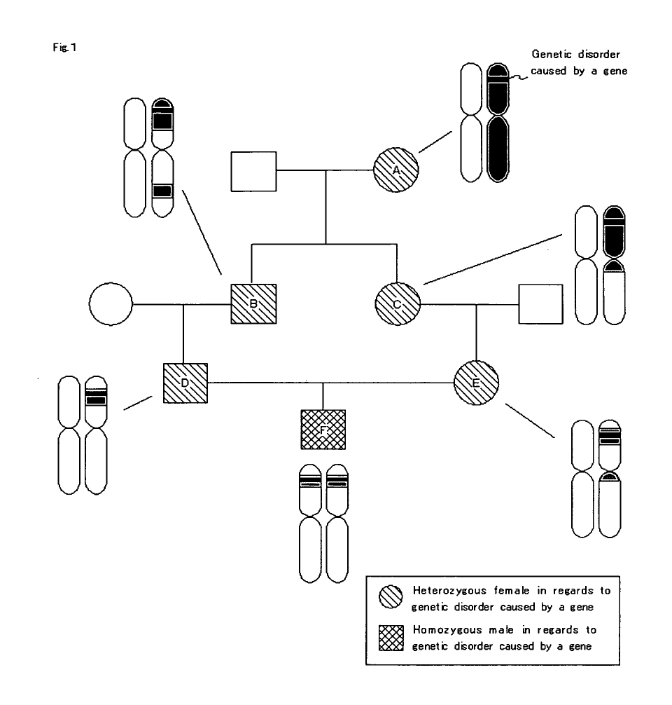

FIG. 2 is an example of a functional diagram of the first embodiment.

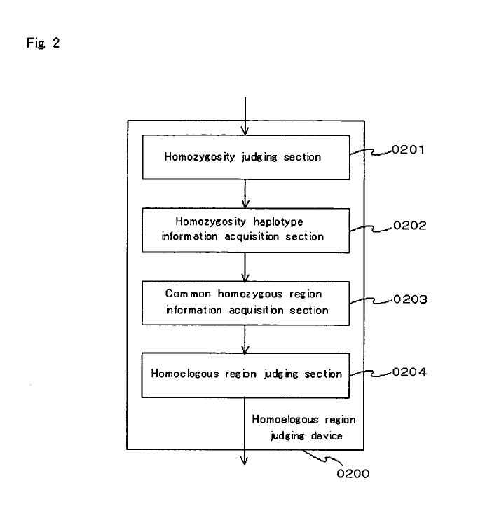

FIG. 3 is an explanatory diagram relating to the concept of a homozygosity haplotype.

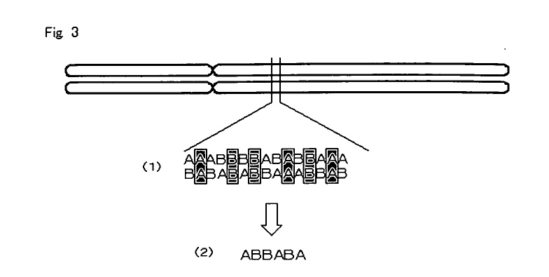

FIG. 4 is a first explanatory diagram relating to the common homozygous region.

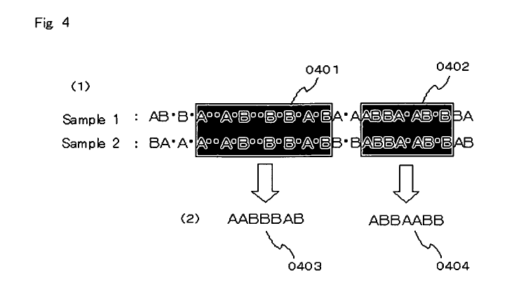

FIG. 5 is a second explanatory diagram relating to the common homozygous region.

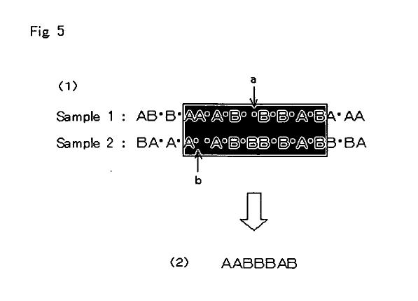

FIG. 6 is an explanatory diagram related to an example of descriptions of processing of the first embodiment.

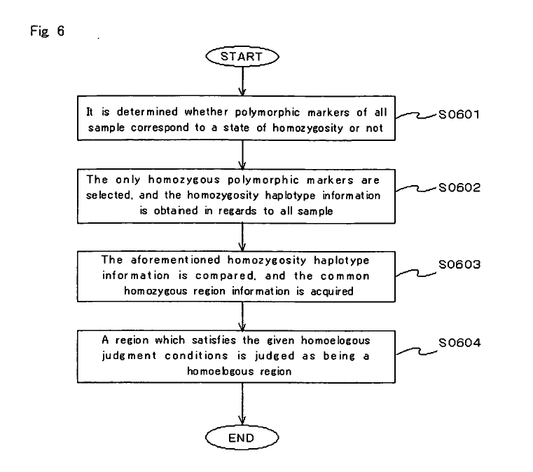

FIG. 7 is an example of a functional diagram of the second embodiment.

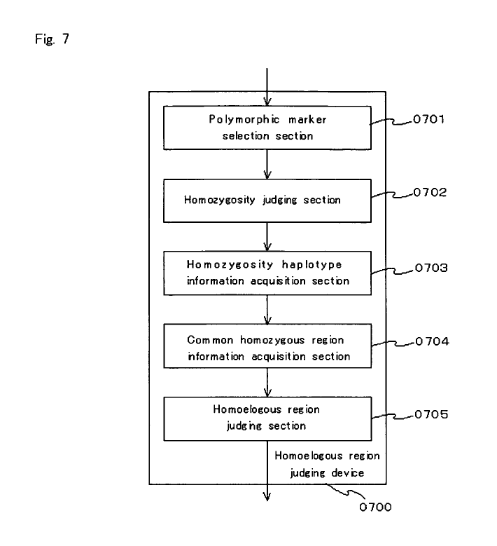

FIG. 8 is an explanatory diagram related to an example of descriptions of processing of the second embodiment.

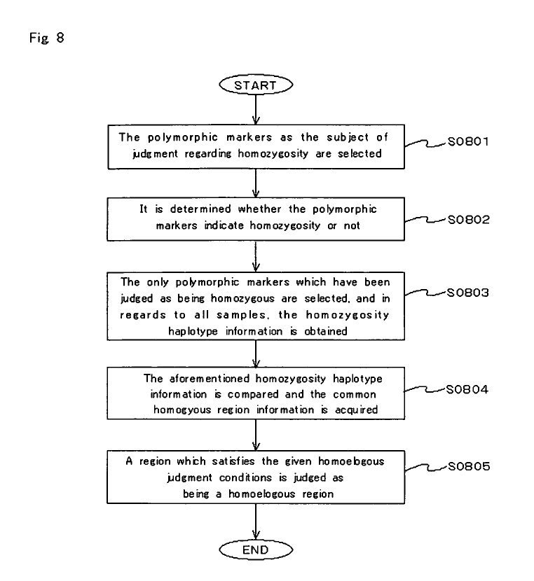

FIG. 9 is an example of a functional diagram of the third embodiment.

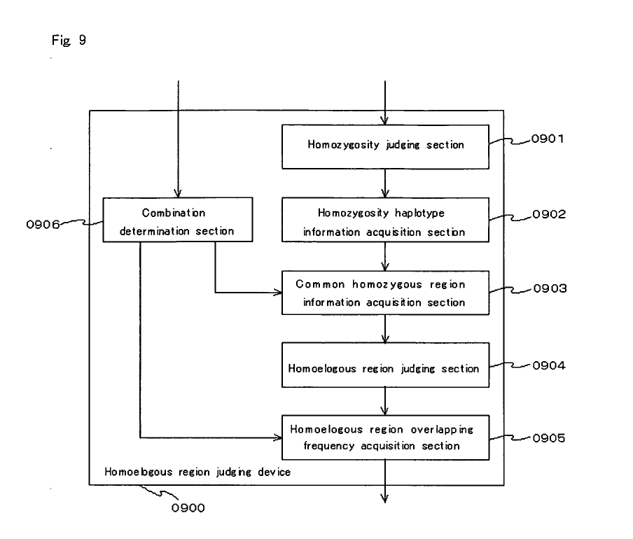

FIG. 10 is an explanatory diagram relating to the concept of homoeologous region overlapping frequency.

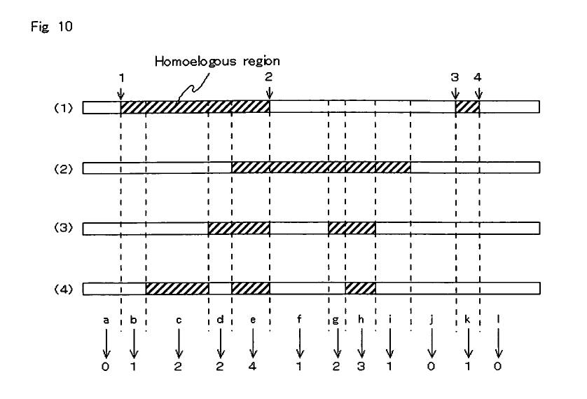

FIG. 11 is an explanatory diagram relating to an example of descriptions of processing of the third embodiment.

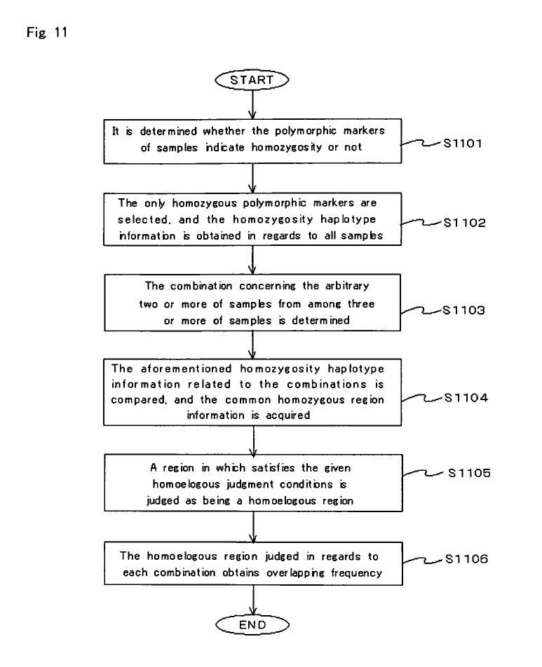

FIG. 12 is an example of a functional diagram of the fourth embodiment.

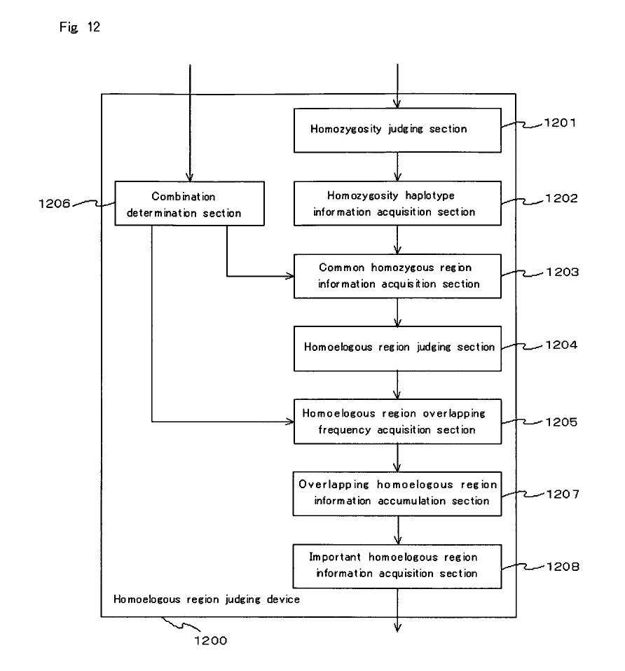

FIG. 13 is an explanatory diagram relating to an example of descriptions of processing of the fourth embodiment.

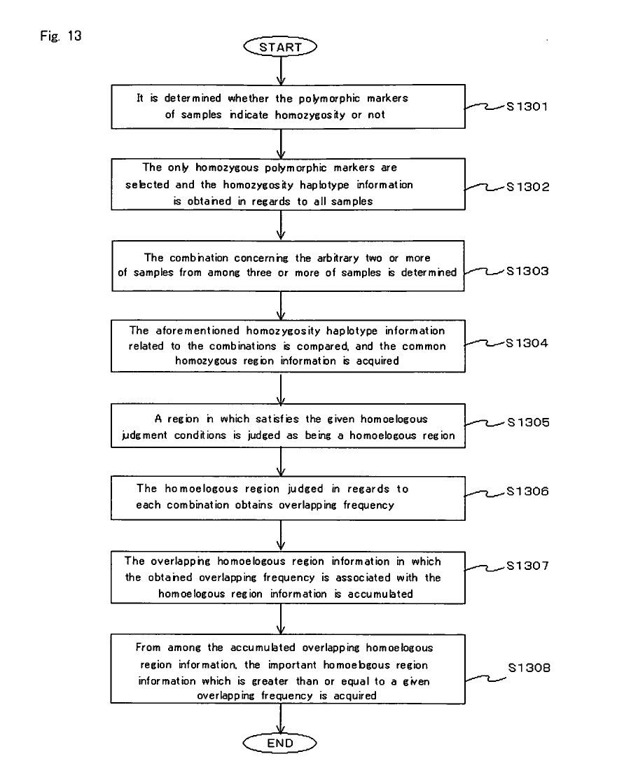

FIG. 14 is an example of a functional diagram of the fifth embodiment.

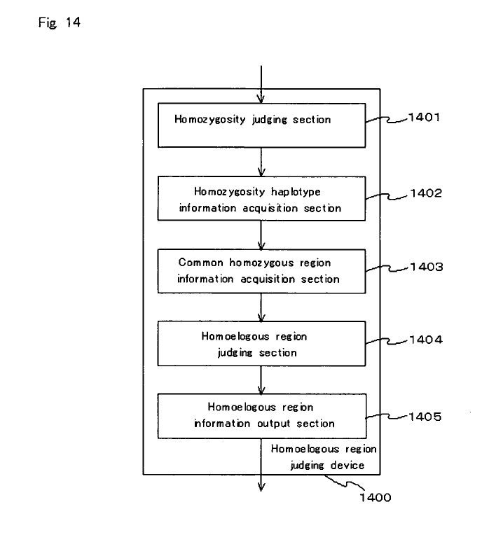

FIG. 15 is a diagram showing the homoeologous regions judged by the homozygosity haplotyping method.

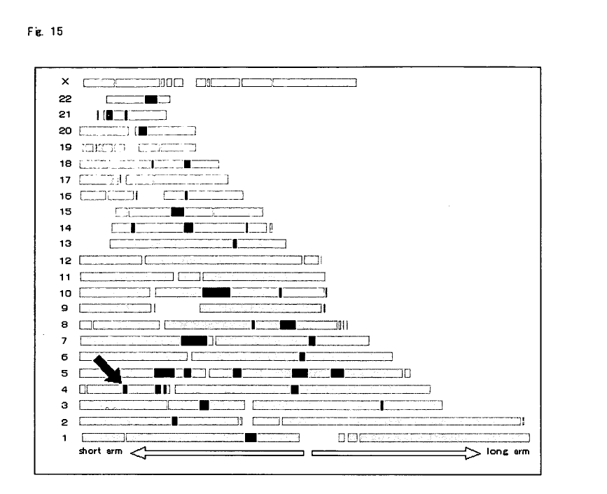

FIG. 16 is an explanatory diagram relating to an example of descriptions of processing of the fifth embodiment.

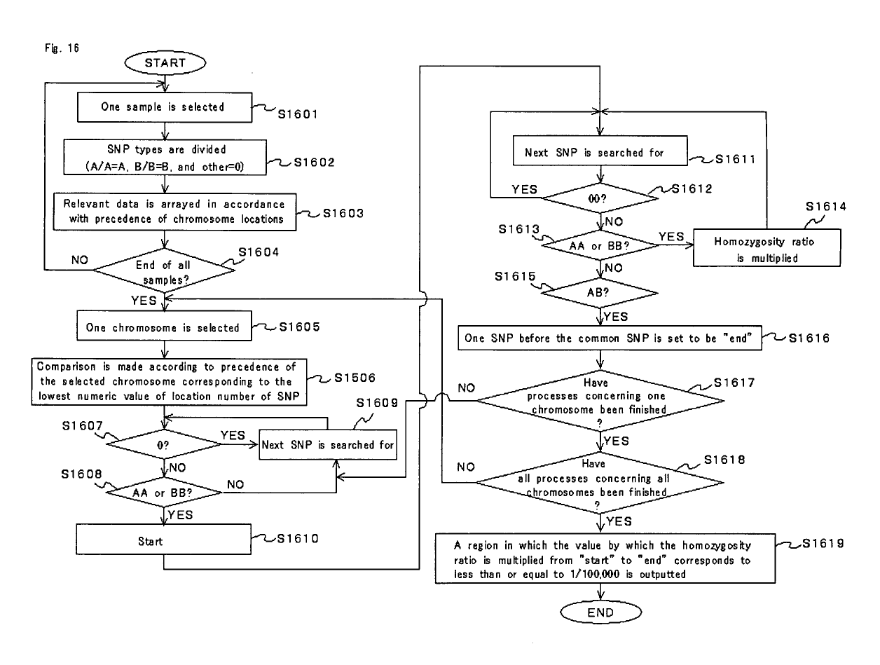

FIG. 17 is a first diagram showing of an example of the homoeologous region programs.

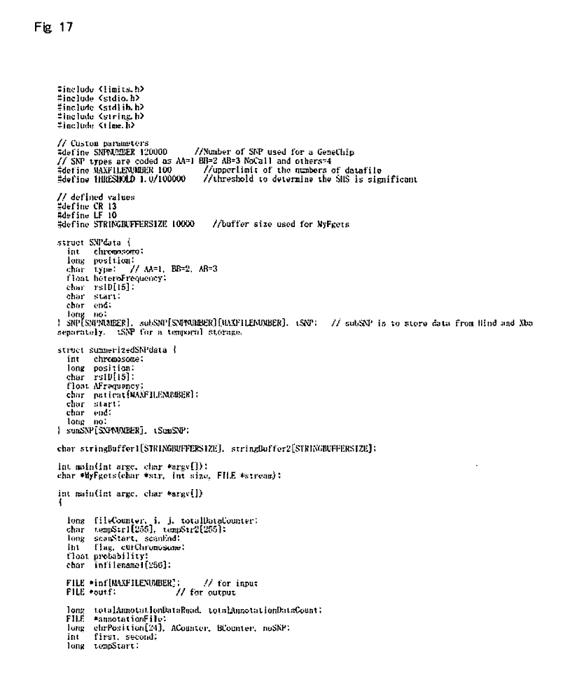

FIG. 18 is a second diagram showing of an example of the homoeologous region programs.

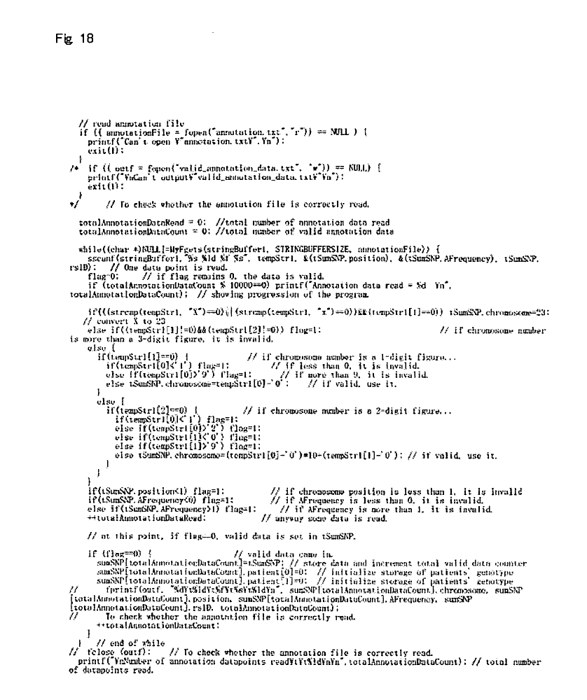

FIG. 19 is a third diagram showing of an example of the homoeologous region programs.

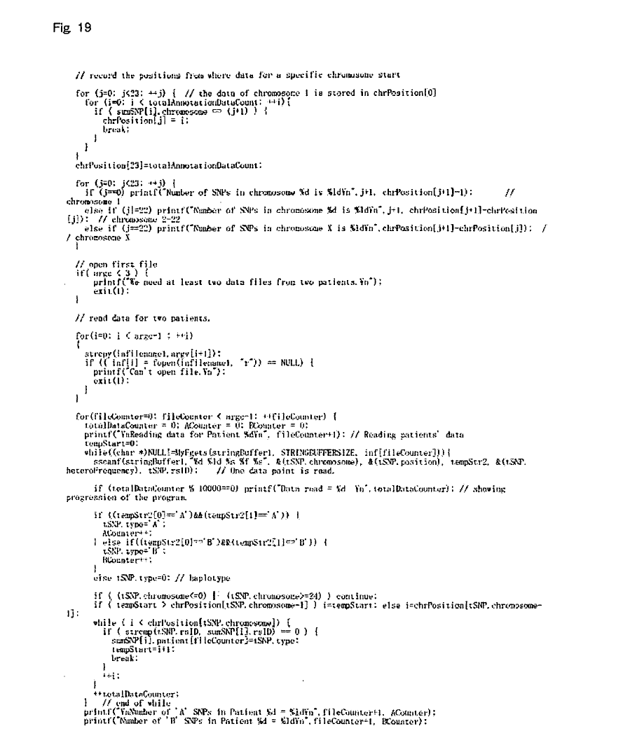

FIG. 20 is a fourth diagram showing of an example of the homoeologous region programs.

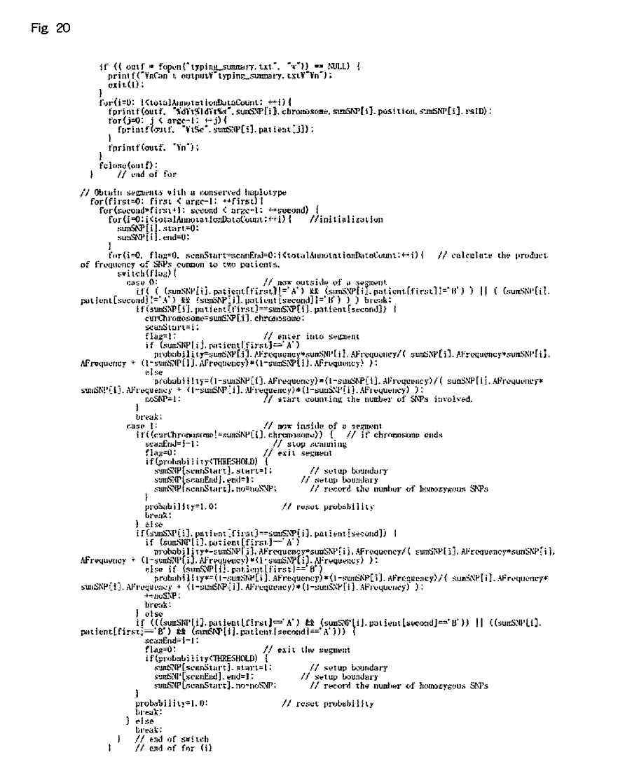

FIG. 21 is a fifth diagram showing of an example of the homoeologous region programs.

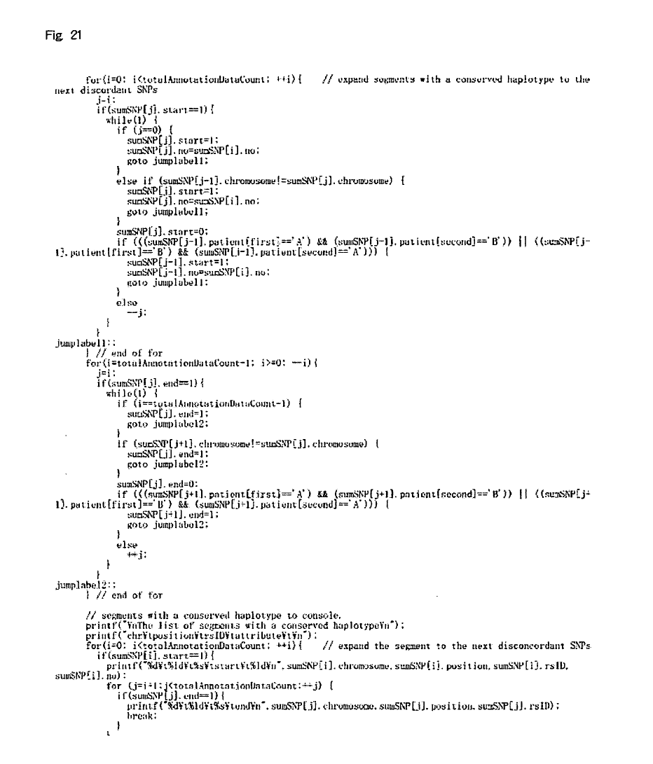

FIG. 22 is a sixth diagram showing of an example of the homoeologous region programs.

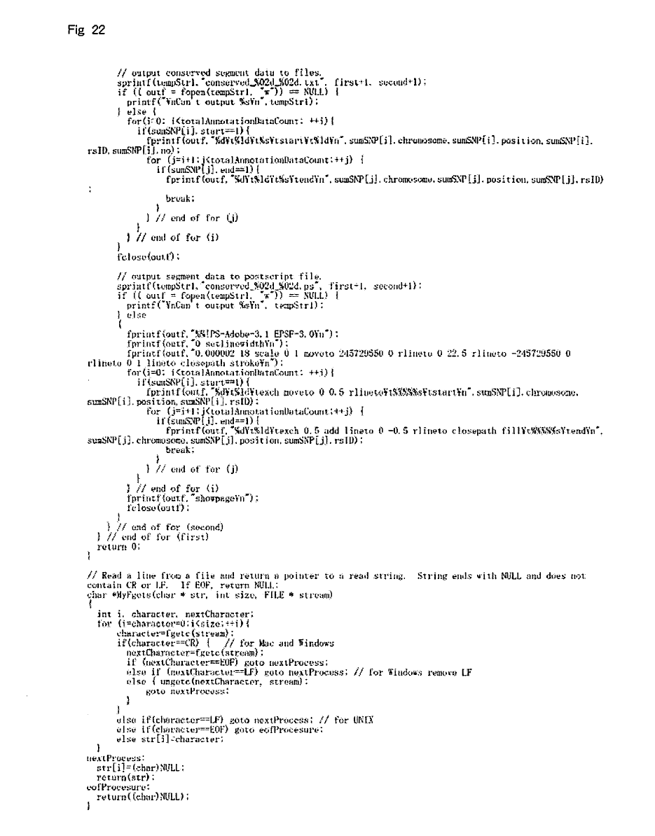

FIG. 23 is an example of a functional diagram of the sixth embodiment.

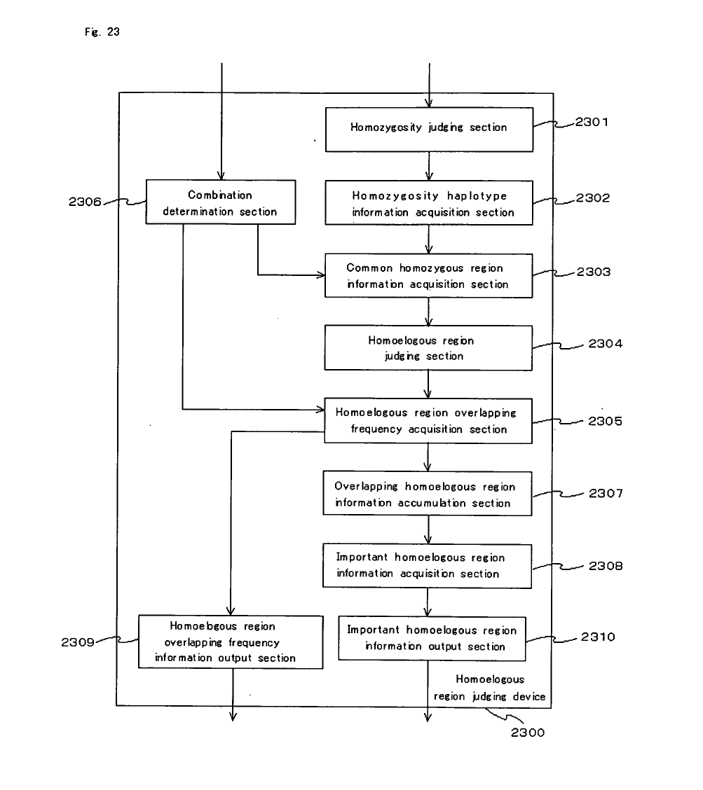

FIG. 24 is a diagram showing an example of output method for homoeologous region overlapping frequency.

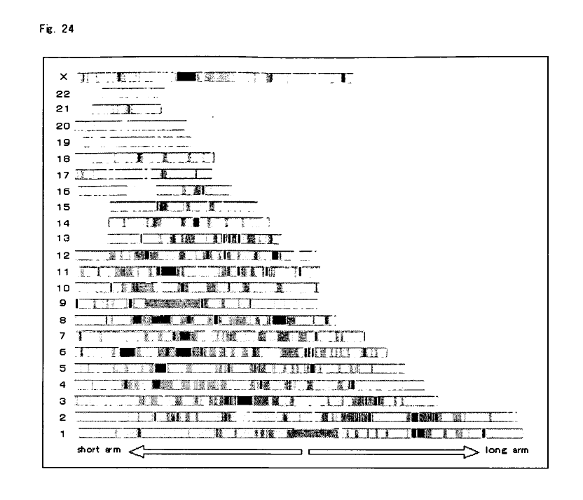

FIG. 25 is a family tree of the patients used as the samples in regards to the Example

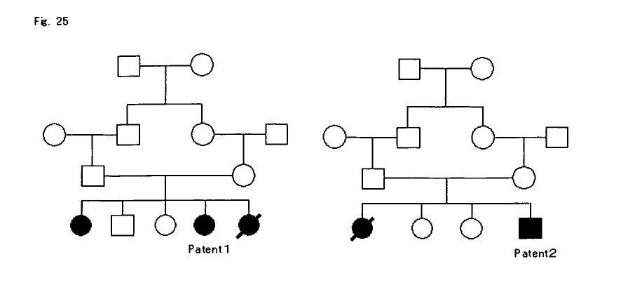

FIG. 26 is a diagram representing the scope of SNPs selected in connection with the Example 1.

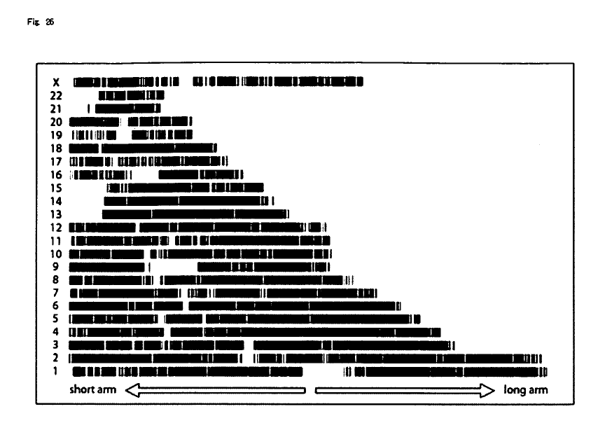

FIG. 27 is a diagram showing homoeologous regions judged by the homozygosity fingerprinting method.

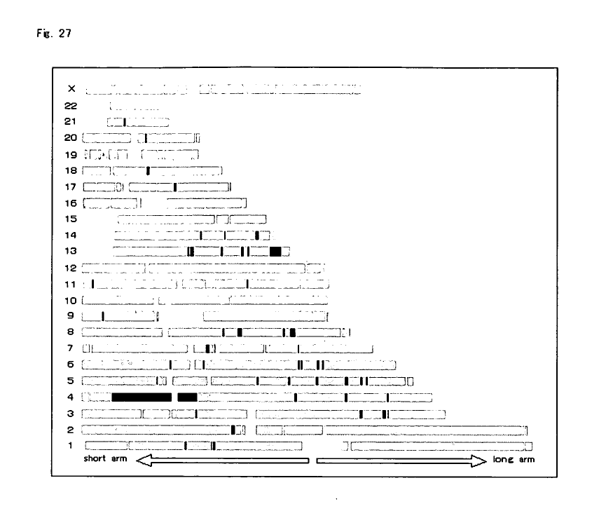

FIG. 28 is a diagram showing common portions of the homoeologous regions judged by the homozygosity haplotyping method and homozygosity fingerprinting method.

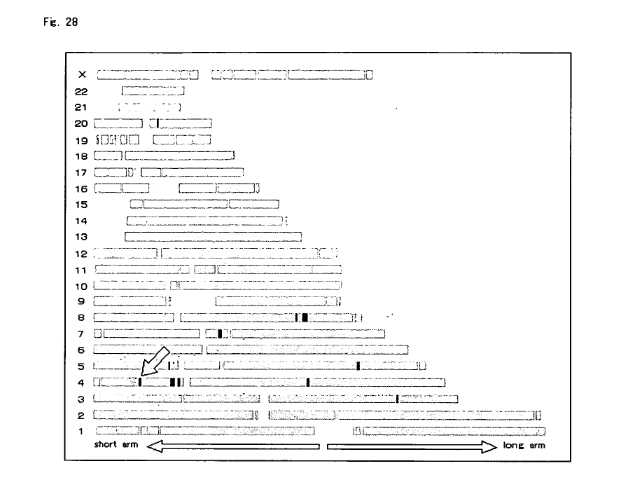

### EXPLANATION OF REFERENCES

0700: Homoeologous region judging device
0701: Polymorphic marker selection section
0702: Homozygosity judging section
0703 :Homozygosity haplotype information acquisition section
0704: Common homozygous region information acquisition section
0705: Homoeologous region judging section
S0801: Polymorphic marker selection step
S0802: Homozygosity judging step
S0803: Homozygosity haplotype information acquisition step
S0804: Common homozygous region information acquisition section
S0805: Homoeologous region judging step

1. A homoeologous region judging method, comprising the steps of:
determining whether bases making up polymorphic markers of one or more DNA samples from a diploid or polyploid organism are homozygous;
acquiring homozygosity haplotype information for each DNA sample through selecting only the polymorphic markers determined to be homozygous from among the polymorphic markers screened by the homozygosity determining step;
acquiring common homozygous region information showing the region with the sequentially same homozygosity haplotype information through making a comparison with the homozygosity haplotype information of two or more of the samples; and
judging that the common homozygous region is a homoeologous region of DNA samples when a continuous probability and/or a continuous distance regarding polymorphic markers in regards to all common homozygous region information satisfy given homoeologous judgment conditions.

2. The homoeologous region judging method of claim 1, further comprising the step of
selecting polymorphic markers to judge for homozygosity from among polymorphic markers of the DNA sample.

3. The homoeologous region judging method of claim 2, wherein the polymorphic marker selection step selects polymorphic markers through all chromosome regions of the DNA sample.

4. The homoeologous region judging method of claim 2, wherein the polymorphic marker selection step selects polymorphic markers included in regions corresponding to candidate genes.

5. The homoeologous region judging method of claim 1, wherein the DNA sample is of plant origin.

6. The homoeologous region judging method of claim 1, wherein the DNA sample is of animal origin.

7. The homoeologous region judging method of claim 6, wherein the animal DNA is of human origin.

8. The homoeologous region judging method of claim 7, wherein the human DNA is of Japanese origin.

9. The homoeologous region judging method of claim 1, wherein the polymorphic markers correspond to single nucleotide polymorphisms.

10. The homoeologous region judging method of claim 1, wherein the polymorphic markers correspond to microsatellite polymorphism.

11. The homoeologous region judging method of claim 1, wherein the polymorphic markers correspond to VNTR polymorphism.

12. The homoeologous region judging method of claim 1, wherein polymorphic markers are based on a combination of two or more of single nucleotide polymorphism, microsatellite polymorphism, or VNTR polymorphism.

13. The homoeologous region judging method of claim 7 wherein the DNA sample is of human origin and wherein 10,000 or more single nucleotide polymorphisms from all chromosome regions of the DNA sample are selected.

14. The homoeologous region judging method of claim 13 wherein 100,000 or more single nucleotide polymorphisms in all chromosome regions are selected.

15. The homoeologous region judging method of claim 1, wherein in regards to the given homoeologous judgment conditions of the common homoeologous region judging step, the continuous probability of a homozygous region of the polymorphic markers shown in the common homozygous region information is a smaller value than that selected from the range of 1/10,000,000 to 1/10,000.

16. The homoeologous region judging method of claim 1, wherein in regards to the given homoeologous judgment conditions of the common homoeologous region judging step, the continuous probability of a homozygous region regarding the polymorphic markers shown in the common homozygous region information is a smaller value than that selected from a scope of 1/5,000,000 to 1/50,000.

17. The homoeologous region judging method of claim 1, wherein in regards to the given homoeologous judgment conditions of the homoeologous region judging step, the continuous probability of a homozygous region regarding the polymorphic markers shown in the common homozygous region information is a smaller value than that selected from a scope of 1/1,000,000 to 1/100,000.

18. The homoeologous region judging method of claim 1, wherein in regards to the given homoeologous judgment conditions of the homoeologous region judging step, the continuous probability of a homozygous region regarding the polymorphic markers shown in the common homozygous region information is a smaller value than that selected from a scope of 1/1,000,000 to 1/5,000.

19. The homoeologous region judging method of claim 1, further comprising the steps of determining the combination of arbitrary two or more of any of any samples from among three or more of samples, and of executing the homozygous judging step, the homozygosity haplotype information acquisition step, the common homozygous region information acquisition step, and the homoeologous region judging step and of acquiring the homoeologous region overlapping frequency in which a region judged as being a homoeologous region in regards to each combination through the homoeologous region judging step.

20. A gene screening method which comprises the steps of:
selecting polymorphic markers to determine for homozygosity from among polymorphic markers of one or more DNA samples taken from a diploid or polyploid organism;
determining whether bases making up the selected polymorphic markers in a genetic sequence from the one or more DNA samples are homozygous;
acquiring homozygosity haplotype information for each DNA sample through selecting only the polymorphic markers determined to be homozygous from among the polymorphic markers screened by the homozygosity determining step;
acquiring common homozygous region information showing a region with sequentially the same homozygosity haplotype information through making a comparison with the homozygosity haplotype information of two or more of the DNA samples;
judging that the common homozygous region is a homoeologous region of DNA samples when a continuous probability and/or a continuous distance regarding polymorphic markers in regards to all common homozygous region information satisfy given homoeologous judgment conditions; and
comparing the genetic sequence with the identified homoeologous region with a corresponding normal gene sequence.

21. The gene screening method of claim 20, wherein comparing the genetic sequence with the identified homoeologous region with the corresponding normal gene sequence to determine if the genetic sequence with the identified homoeologous region is a gene known to function in a homozygous state.

22. The gene screening method of claim 20 wherein comparing the genetic sequence with the identified homoeologous region with the corresponding normal gene sequence to determine if the genetic sequence with the identified homoeologous region is a gene related to a corresponding disease.

23. A homoeologous region judging device, comprising a central processing unit with a program including:
a homozygosity judging section to determine whether bases making up the selected polymorphic markers in a genetic sequence from the one or more DNA samples are homozygous;
a homozygosity haplotype information acquisition section to acquire homozygosity haplotype information for each DNA sample through selecting only the polymorphic markers determined to be homozygous from among the polymorphic markers screened by the homozygosity judging section;
a common homozygous region information acquisition section that compares homozygosity haplotype information of two or more of the DNA samples to obtain common homozygous region information showing a region with sequentially the same homozygosity haplotype information; and
a homoeologous region judging section to judge that the common homozygous region is a homoeologous region of the DNA samples when a continuous probability and/or a continuous distance regarding polymorphic markers in regards to all common homozygous region information satisfy given homoeologous judgment conditions.

24. The homoeologous region judging device of claim 23, further comprising:
a polymorphic marker selection section to determine for homozygosity from among polymorphic markers of the one or more DNA samples.

25. The homoeologous region judging device of claim 24, wherein the polymorphic marker selection section selects polymorphic markers for all chromosome regions of the one or more DNA samples.

26. The homoeologous region judging device of claim 24, wherein the polymorphic marker selection section selects polymorphic markers included in regions corresponding to candidate genes.

27. The homoeologous region judging device of claim 23, wherein the DNA sample is of plant origin.

28. The homoeologous region judging device of claim 23, wherein the DNA sample is of animal origin.

29. The homoeologous region judging device of claim 28, wherein the animal DNA is of human origin.

30. The homoeologous region judging device of claim 29, wherein the human DNA is of Japanese origin.

31. The homoeologous region judging device of claim 23, wherein the polymorphic markers are single nucleotide polymorphisms.

32. The homoeologous region judging device of claim 23, wherein the polymorphic markers are microsatellite polymorphisms.

33. The homoeologous region judging device of claim 23, wherein the polymorphic markers are VNTR polymorphisms.

34. The homoeologous region judging device of claim 23, wherein polymorphic markers are a combination of any two or more of single nucleotide polymorphism, microsatellite polymorphism, or VNTR polymorphism.

35. The homoeologous region judging device of claim 23 wherein the DNA sample is of human origin and the polymorphic marker selection section selects 10,000 or more single nucleotide polymorphisms from all chromosome regions of the DNA sample.

36. The homoeologous region judging device of claim 23 wherein the DNA sample is of human origin and the polymorphic marker selection section selects 100,000 or more single nucleotide polymorphisms in all chromosome regions of the DNA sample.

37. The homoeologous region judging device of claim 23 wherein in regards to the given homoeologous judgment conditions, the continuous probability of the polymorphic markers of the region shown in the common homozygous region information is a smaller value than that selected from a scope of 1/10,000,000 to 1/10,000 at the homoeologous region judging section.

38. The homoeologous region judging device of claim 23 wherein in regards to the prescribed judgment conditions, the continuous probability of the polymorphic markers of the region shown in the common homozygous region information is a smaller value than that selected from a scope of 1/5,000,000 to 1/50,000 at the homoeologous region judging section.

39. The homoeologous region judging device of claim 23 wherein in regards to the given homoeologous judgment conditions, the continuous probability of the polymorphic markers of the region shown in the common homozygous region information is a smaller value than that selected from a scope of 1/1,000,000 to 1/100,000 at the homoeologous region judging section.

40. The homoeologous region judging device of claim 23 wherein in regards to the given homoeologous judgment conditions, the continuous probability of the polymorphic markers of the region shown in the common homozygous region information is a smaller value than that selected from a scope of 1/1,000,000 to 1/5,000 at the homoeologous region judging section.

41. The homoeologous region judging device of claim 23 further comprising a homoeologous region information output section which visualizes and outputs the homoeologous region information as information showing the common homozygous region judged to satisfy the given homoeologous judgment conditions by the homoeologous region judging section.

42. The homoeologous region judging device of claim 23, further comprising:
a combination determination section which determines the combination of arbitrary two or more DNA samples from among three or more DNA samples; and
a homoeologous region overlapping frequency acquisition section in which a region judged as being a homoeologous region by the homoeologous region judging section in regards to each combination determined through the combination determination section acquires overlapping frequency among other combinations;
wherein the common homozygous region information acquisition section obtains the common homozygous region information through making a comparison of the homozygosity haplotype information of samples in regards to the combinations determined by the combination determination section.

43. The homoeologous region judging device of claim 42, further comprising a homoeologous region overlapping information output section that outputs the homoeologous region overlapping frequency information corresponding to visualized and outputted homoeologous region overlapping frequency obtained by the homoeologous region overlapping frequency acquisition section.

44. The homoeologous region judging device of claim 43, further comprising:
an overlapping homoeologous region information accumulation section that accumulates the overlapping homoeologous region information showing the homoeologous region information associated with the homoeologous region overlapping frequency obtained through the homoeologous region overlapping frequency acquisition section; and
an important homoeologous region information acquisition section in which from among the overlapping homoeologous region information accumulated in the overlapping homoeologous region information accumulation section, the important homoeologous region information showing the homoeologous region information associated with an overlapping frequency that is greater than or equal to a given overlapping frequency is acquired.

45. The homoeologous region judging device of claim 44, further comprising an important homoeologous region information output section that visualizes and outputs the important homoeologous region overlapping information obtained by the important homoeologous region information acquisition section.

46. A gene screening method in which genetic sequences included in the homoeologous regions judged by the homoeologous region judging devices of claim 23 are identified and are compared with sequences of normal genes.

47. A gene screening method in which in case that the homoeologous region information identified by the homoeologous region judging devices of claim 23 is overlapped with the homoeologous region information that is accumulated in the important homoeologous region information accumulation section, the gene sequences included in the overlapping region are identified and compared with the sequences of normal genes.

48. A gene screening method in which it is judged whether or not the homoeologous regions judged by the homoeologous region judging devices of claim 23 could contain genes that have already been known to function in a homozygous state, and in the case of a region that could contain a gene that has been already known, sequences of corresponding known genes and corresponding genes of sample DNA are compared.

49. A gene screening method in which in case that the sample DNA corresponds to a disease, if the homoeologous regions judged by the homoeologous region judging devices of claim 23 contain a gene that is expected to be related to a corresponding disease, the sequences of the corresponding genes in the homoeologous region of the sample DNA are identified and compared with normal genes.
